(19) United States
(12) Patent Application Publication
(10) Pub. No.: US 2026/0105712 A1
(43) Pub. Date: Apr. 16, 2026

(54) MIXED REALITY SYSTEM FOR ADVANCED DRIVER ASSISTANCE SYSTEMS TESTING, DRIVER TRAINING AND DRIVING ENTERTAINMENT

(71) Applicant: Clemson University, Clemson, SC (US)

(72) Inventors: Yunyi Jia, Clemson, SC (US); Rongyao Wang, Clemson, SC (US); Ardalan Vahidi, Clemson, SC (US)

(73) Assignee: Clemson University, Clemson, SC (US)

(21) Appl. No.: 19/358,876

(22) Filed: Oct. 15, 2025

Related U.S. Application Data
(60) Provisional application No. 63/707,244, filed on Oct. 15, 2024.

(51) Int. Cl. G06T 19/20; B60W 50/00; B60W 50/04; G06T 7/11; G06T 7/73; G06V 20/20; G06V 20/56; G07C 5/06

(52) U.S. Cl. CPC G06T 19/20; G06T 7/11; G06T 7/73; G06V 20/20; G06V 20/588; G07C 5/06; B60W 2050/0054; B60W 50/045; G06T 2207/30236; G06T 2207/30252; G06T 2219/2004

(57) ABSTRACT

A mixed reality system for vehicle testing and validation is provided, comprising: a vehicle platform including a vehicle controller and sensor array; a mixed reality headset configured to superimpose virtual traffic objects onto a real-world driving environment through optical see-through display technology; a traffic microsimulation component configured to generate virtual traffic scenarios and provide position, velocity, and acceleration data of virtual vehicles; a local object pose correction component configured to process captured images from the real-world driving environment to detect positioning errors of virtual traffic objects relative to road boundaries and calculate pixel-based corrections to maintain accurate spatial alignment between virtual traffic objects and physical road surfaces; and a communications system configured to coordinate data exchange between the vehicle platform, mixed reality headset, traffic microsimulation component, and local object pose correction component at enhanced frame rates of at least 120 Hz.

### RELATED APPLICATIONS

This application claims priority and relates to U.S. Provisional Patent Application No. 63/707,244 filed Oct. 15, 2025, which is hereby incorporated by reference in its entirety.

This invention was made with government support under 1F-60368 awarded by the Department of Energy. The government has certain rights in the invention.

### BACKGROUND OF THE INVENTION

### 1) Field of Invention

This system is a mixed reality platform for vehicle testing and validation that integrates real-world driving environments with virtual traffic scenarios.

### 2) Description of the Related Art

Current vehicle testing and validation systems face substantial limitations in their ability to provide realistic and safe testing environments for advanced driver assistance systems (ADAS) and autonomous vehicle technologies. Traditional approaches rely on either purely virtual simulations that lack the physical dynamics and psychological factors of real-world driving, or on-road testing that poses safety risks and limits the complexity of scenarios that can be evaluated. These conventional methods struggle to bridge the gap between controlled laboratory conditions and the unpredictable nature of actual driving environments, resulting in validation processes that may not adequately prepare systems for real-world deployment.

Existing mixed reality implementations for vehicle applications are primarily limited to stationary or highly controlled environments, as current technology does not allow drivers to operate mixed reality systems safely with moving vehicles in real-world situations. The synchronization challenges between virtual content and rapidly changing physical environments, combined with localization accuracy issues in outdoor settings, create significant barriers to effective mixed reality integration in dynamic driving scenarios. These technical limitations prevent the development of comprehensive testing platforms that could leverage the benefits of both virtual flexibility and real-world authenticity.

The current state of the technology is not able to take advantage of developing technologies such as improved artificial intelligence, real-world data capture capabilities, rapid remote processing power, and sophisticated human and machine input systems. This technological gap limits the potential for creating advanced validation frameworks that could significantly enhance the safety and effectiveness of autonomous vehicle development while reducing the time and cost associated with traditional testing methodologies.

It is an object of the present system to provide a mixed reality platform that enables safe and realistic testing of vehicle systems by seamlessly integrating real-world driving environments with virtual traffic scenarios through advanced localization and synchronization algorithms.

It is another object of the present system to provide real-time virtual object localization and correction capabilities that enhance mixed reality accuracy and stability in outdoor driving environments.

It is another object of the present system to provide human-vehicle-in-the-loop validation capabilities that allow for naturalistic driver behavior analysis in controlled yet realistic mixed traffic scenarios.

It is another object of the present system to provide an optical see-through mixed reality framework that maintains reality rendering while enabling complex traffic scenario testing without compromising driver safety.

### BRIEF SUMMARY OF THE INVENTION

The above objectives are accomplished by providing a mixed reality system for advanced driver assistance comprising a vehicle having a vehicle communication array, a controller included in the vehicle, and a mixed reality display included in the vehicle and adapted for superimposing a virtual vehicle overtop an actual physical scene, wherein the controller is adapted to provide a planned route and conditions, control the vehicle and using a sensor array, sense the environment in which the vehicle operates and displaying the performance of the vehicle under these conditions.

The controller may be adapted to use on-track “X”-in-the-loop (XIL) testing for connected and automated vehicles (CAVs) where a real vehicle ran on a test track with CAV traffic microsimulation in the loop to validate an intersection control scheme without requiring physical road infrastructure such as traffic lights for testing. The “X” in XIL can represent different components that are integrated “in the loop,” such as: Hardware-in-the-Loop (HIL), Software-in-the-Loop (SIL), Vehicle-in-the-Loop (VIL) and Human-in-the-Loop (HIL). The controller may be adapted to blend the physical and virtual worlds to orchestrate CAV test setups for various validations and display an augmented reality to a user. The controller may be a first controller, and the first controller may be adapted to communication with a second controller in a second vehicle wherein the second vehicle is a virtual vehicle. The controller may be adapted to provide virtual environmental elements to a display provided to a user.

The controller may drive two motors for steering, throttle and brake actuation. The controller may be adapted to record powertrain characteristics on a chassis dynamometer and model it through a data-driven approach to ensure accurate drive-by-wire (DBW) control. The system may include a sensor suite included in the vehicle to enable localization and potential mapping of the surroundings. The system may include a virtual vehicle programmed with an interaction model to either replicate human driving patterns or autonomous driving behavior. The controller may provide virtual infrastructure synthesized, along with supporting visuals such as roads, signs and the like.

The system may include robot operating software adapted as middleware to implement autonomy on the vehicle platform. The system may include a mixed reality device as an onboard simulation platform for human drivers to wear while driving on the test track so that the driver can visualize the augmented testing site with virtual traffic objects included. The system may include a microsimulation that can include a digital twin of the human-driven vehicle on the testing track and provide updated surrounding traffic information to an onboard computer that will upgrade the 2D traffic information to 3D realistic traffic information that aligns with the testing site environment.

The system may include a wearable headset providing a projection of holograms onto the physical environment using a reflective projected hologram so that a driver can still see the real environment even when the power is turned off. The wearable headset may be adapted to allow the human driver to perceive projected traffic objects. The controller in communications with the vehicle may be adapted to send human-driven vehicle's information back to a microsimulation to form a closed-loop simulation. The controller may operate in one of three modes selected from the group consisting of vehicle-to-vehicle, vehicle-to-infrastructure, and vehicle-to-human connectivity. The controller may be adapted to use human-autonomy mixed where human-driven vehicles were allowed to be involved in the CAV traffic flow and analyze its impact on traffic and autonomous vehicle (AV) control.

The controller may be adapted to validate CAV technologies. A local virtual hologram may be corrected and adjusted. The system may include an augmented reality device mounted inside the vehicle and adapted to capture an augmented reality image stream. The captured images may be further processed, for instance segmentation for road. The captured images may be further processed for object detection for virtual vehicles. A virtual hologram may be analyzed to detect if it violates real world boundaries such as derail from road requiring lateral correction, lifting in the air or diving into the ground which can require pitch correction. A set of computer readable instructions may detect that a hologram's pose needs adjustment, capture the pixel deviance based on the processed image, and calculate the corresponding global position deviance based on the pre-calibrated camera parameters.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a block diagram of aspects of the system;

FIGS. 2, 3, and 4 are block diagrams of aspects of the system;

FIGS. 5 and 6 are illustrations of aspects of the system;

FIGS. 7A and 7B are views of aspects of the system;

FIGS. 8, 9, and 10 are comparative plots of aspects of the system;

FIG. 11 is a graph of aspects of the system;

FIGS. 12A and 12B are comparative graphs of aspects of the system;

FIGS. 13A, 13B, and 13C are graphs of aspects of the system;

FIGS. 14 and 15 are trajectory comparison graphs of aspects of the system;

FIGS. 16A and 16B are segmentation comparison images of aspects of the system; and,

FIG. 17 is a communication architecture diagram of aspects of the system.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first” and “second” may be used to differentiate elements, but the modifiers do not necessarily indicate any particular order.

This mixed reality system represents a significant advancement over current vehicle testing methodologies by enabling safe, realistic validation of advanced driver assistance systems through seamless integration of real-world driving dynamics with virtual traffic scenarios. Unlike existing approaches that rely on either purely virtual simulations lacking physical authenticity or dangerous on-road testing with limited scenario complexity, this system provides a controlled yet naturalistic testing environment that maintains the psychological and physical factors of actual driving while eliminating safety risks. The enhanced frame rate processing, in one embodiment in excess of 120 Hz with real-time pose correction algorithms, addresses the synchronization and localization challenges that have previously prevented effective mixed reality implementation in dynamic driving environments, enabling human drivers to interact naturally with virtual traffic objects that maintain realistic spatial and temporal characteristics indistinguishable from real vehicle interactions.

In this description, the term pose can be a spatial description of an object's position and orientation in three-dimensional space.

With reference to the drawings, the invention will now be described in more detail.

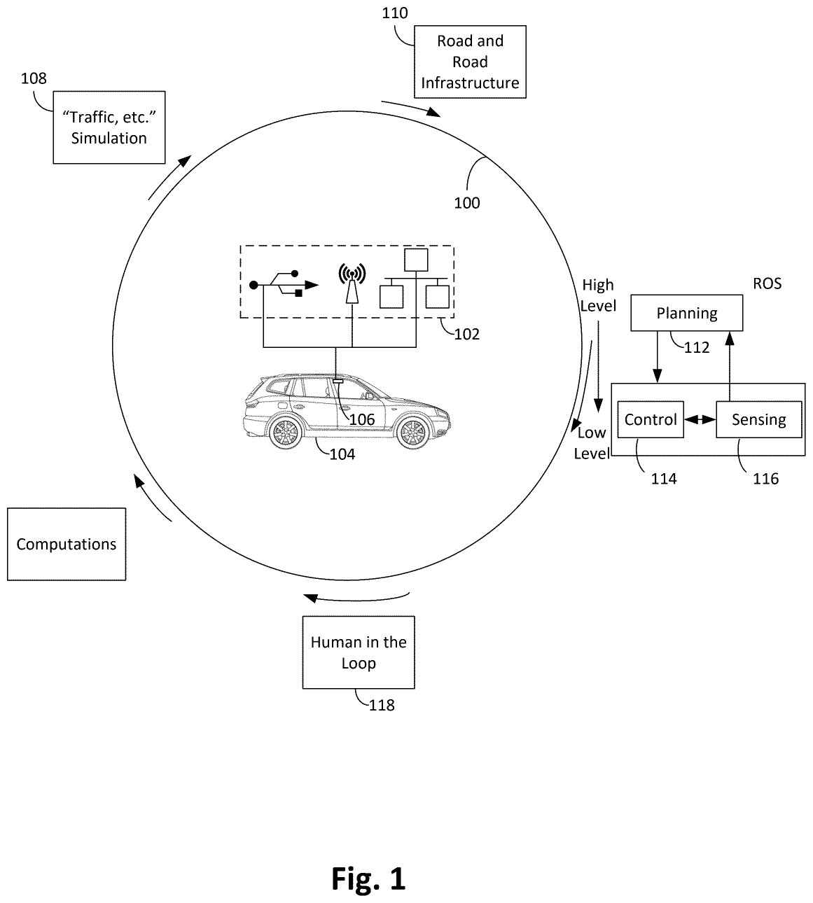

Referring to FIG. 1, a process loop 100 forms the foundation of the mixed reality validation system architecture. The process loop 100 includes a communications system 102 that interconnects all system components and enables data exchange between physical and virtual elements. A vehicle platform 104 serves as the physical foundation for the mixed reality system and houses the various hardware and software components needed for autonomous vehicle testing and validation.

The vehicle platform 104 includes a vehicle controller 106 that manages the overall operation of the system. In one embodiment, the vehicle platform 104 can be a traditional vehicle (e.g., Mazda CX7) retrofitted to be DBW capable through a real-time controller board that drives two motors for steering, throttle and brake actuation. The vehicle controller 106 processes environmental information 108 and environment articles 110 that represent real-world conditions and virtual objects within the mixed reality environment.

A planner module 112 receives and processes environmental information 108 and environment articles 110 to generate high-level planning decisions for the vehicle platform 104. The planner module 112 communicates with control algorithms 114 that implement the planned actions through low-level control commands. In one configuration, the system uses Robot Operating Software (ROS) as middleware to implement autonomy on the vehicle platform 104 with modular and hierarchical structure including high-level planner and low-level DBW control algorithms.

Sensors 116 provide real-time data about the vehicle's surroundings and operational state to support the control algorithms 114 and planner module 112. In one example, the sensors 116 include a Novatel PwrPak7 unit with dual antennas providing high-confidence internal navigation system (INS) data with centimeter-level accuracy through fusion of real time kinematic (RTK), global positioning system (GPS), and inertial measurement unit (IMU) data, along with lidar systems, cameras systems, and radar systems. The sensors 116 enable precise localization and environmental perception needed for accurate mixed reality object placement and vehicle control.

A vehicle-to-human depiction 118 facilitates interaction between the vehicle platform 104 and human operators or test subjects. The vehicle-to-human depiction 118 enables the presentation of virtual traffic objects and scenarios to human drivers through mixed reality displays while maintaining connection to the physical vehicle dynamics and real-world environment.

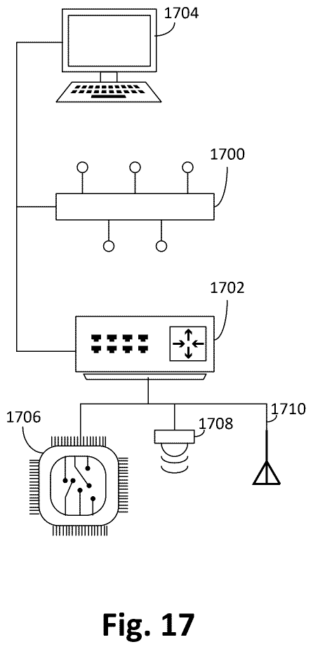

Referring to FIG. 17, the communications system 102 can include a cellular network gateway 1700 that provides connectivity to external networks and remote systems. A network router 1702 manages data flow within the system and connects to the cellular network gateway 1700 to enable communication with external resources. Network router 1702 facilitates communication between a remote computer device 1704 and a vehicle computer device 1706, allowing for distributed processing and remote monitoring capabilities.

The vehicle computer device 1706 interfaces with a sensor 1708 to collect real-time data from the vehicle platform 104. An antenna 1710 can connect to the network router 1702 to enable wireless communications throughout the system. The communications system 102 coordinates data exchange between all system components, ensuring that virtual objects, sensor data, and control commands are synchronized across the mixed reality validation platform.

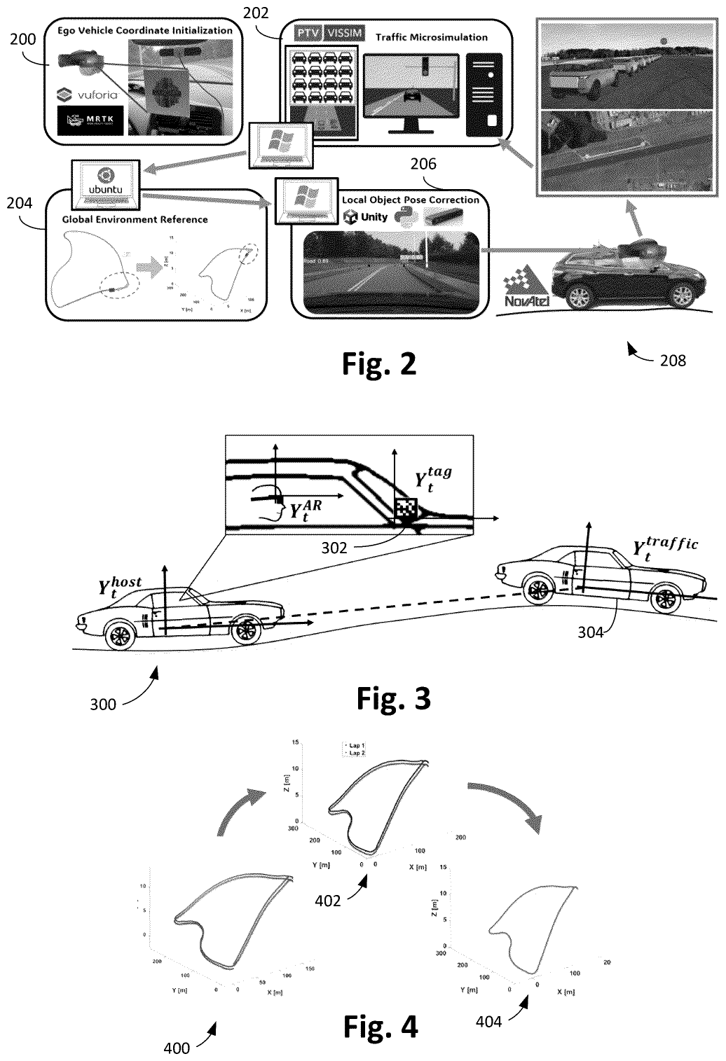

Referring to FIG. 2, the mixed reality human-vehicle-in-the-loop validation framework includes five interconnected components that enable comprehensive testing of autonomous vehicle systems in mixed traffic scenarios. The system can use an “ego vehicle” which can be the primary test vehicle that serves as the reference point or subject vehicle in the mixed reality validation system. An ego vehicle coordinate initialization 200 establishes the coordinate system foundation by initializing virtual traffic objects within the ego vehicle's reference frame and preparing the system for simulation operations. The ego vehicle coordinate initialization 200 builds the coordinate transformation between the ego vehicle and the mixed reality headset to ensure proper alignment of virtual and physical elements.

A traffic microsimulation module 202 generates realistic traffic flow patterns and provides traffic flow information including position, velocity, and acceleration data of surrounding vehicles along the road to the ego vehicle. In one embodiment, the traffic microsimulation module 202 uses traffic simulator software to create dynamic traffic scenarios with multiple virtual vehicles that interact with the physical ego vehicle. The traffic microsimulation module 202 creates a digital twin of the real ego vehicle within the online simulator using coordinates from the vehicle's positioning system, enabling synchronized interaction between physical and virtual elements.

A global environment reference module 204 transforms the microsimulation information based on the real surrounding environment for display in the mixed reality headset. The global environment reference module 204 converts two-dimensional traffic flow information from native coordinates into three-dimensional on-road traffic information that corresponds to the actual test environment. The global environment reference module 204 assists in having virtual traffic objects appear correctly positioned relative to the physical road surface and environmental features.

A local object pose correction module 206 addresses localization errors and noise from the positioning system and other positioning devices that can cause unrealistic virtual object positioning. The local object pose correction module 206 implements real-time correction algorithms to maintain accurate placement of virtual traffic objects relative to the road surface and ego vehicle position. In one configuration, the local object pose correction module 206 uses an augmented reality camera to capture simulation images for image processing and correction algorithm implementation. In one embodiment the camera is a stereo vision camera system that uses two lenses to capture depth and create a 3D model of its surroundings. The cameras can be adapted for a range of applications, including digital twins, augmented reality, feature advanced depth sensing, AI capabilities, and various environmental sensors.

An on-site human driving test functionality 208 enables human drivers wearing mixed reality headsets to operate the test vehicle along predetermined test tracks while interacting with virtual traffic scenarios. The on-site human driving test 208 provides the platform for collecting human driver response data and validating the realism of the mixed reality environment through direct human-vehicle interaction.

Referring to FIG. 3, the coordinate transformation framework enables accurate positioning of virtual traffic objects within the mixed reality environment through a systematic transformation process. The framework includes a component for finding 3D pose information of traffic objects 300 that determines the three-dimensional position and orientation data for all virtual vehicles within the simulation environment. The find 3D pose information of traffic objects 300 component processes traffic data from the traffic microsimulation 202 and applies road profile information to establish accurate spatial positioning.

A vision and image bridge module 302 facilitates the connection between the mixed reality headset's coordinate system and the ego vehicle's coordinate system through computer vision techniques. In one example, the vision and image bridge module 302 uses a software development kit (SDK) that enables the system to provide augmented reality (AR) functionality by using advanced computer vision capabilities to the system. The system can use a camera to detect and track images, objects, and spaces, allowing digital content to be overlaid onto the real world in a stable and realistic way. This SDK can be used to detect a pre-calibrated image tag to obtain the transformation matrix between the mixed reality device and the ego vehicle for coordinate alignment. The vision and image bridge 302 enables real-time tracking of the headset position relative to the vehicle platform 104.

A traffic module 304 manages the virtual traffic objects and their positioning within the mixed reality display. The traffic module 304 receives processed coordinate information and renders virtual vehicles at the correct positions within the driver's field of view through the mixed reality headset. The coordinate transformation process follows a systematic approach to convert traffic object positions from global coordinates to the mixed reality headset coordinate system. The transformation from global coordinates to ego vehicle coordinates follows

$${Y}_{t}^{ego , traffic} = {T}_{global \to ego} \cdot ( {Y}_{t}^{global , traffic} - {Y}_{t}^{global , ego} ) = \qquad ( 1 )$$

where the pose representation Y contains three-dimensional position information and three-dimensional Euler rotation information, and the transformation matrix T represents the coordinate frame conversion.

The subsequent transformation from ego vehicle coordinates to headset coordinates follows:

$${Y}_{t}^{headset , traffic} = {T}_{tag \to headset} \cdot {T}_{ego \to tag} \cdot {Y}_{t}^{ego , traffic} \qquad ( 2 )$$

where the transformation matrix between the mixed reality headset coordinates and the image tag coordinates enables precise virtual object placement within the driver's visual field.

Referring to FIG. 4, the data processing flow demonstrates the systematic approach to generating accurate pose information for virtual traffic objects. Raw location data 400 represents the initial positioning information collected from position sensors and other localization sources. The raw location data 400 contains inherent noise and errors that can compromise the accuracy of virtual object placement.

Raw location data processed 402 represents the intermediate stage where filtering algorithms and correction techniques are applied to improve the quality and accuracy of the positioning information. The raw location data processed 402 undergoes multiple processing steps including noise reduction, coordinate transformation, and temporal smoothing to prepare the data for use in the mixed reality system.

A resulting pose 404 represents the final, corrected position and orientation information that is used to place virtual traffic objects within the mixed reality environment. The resulting pose 404 provides the accurate spatial coordinates and orientation data needed to ensure that virtual vehicles appear correctly positioned on the road surface and maintain realistic spatial relationships with the ego vehicle and physical environment.

With continued reference to FIG. 4, the road reference construction process transforms the raw location data 400 into accurate spatial references through systematic filtering and processing of recorded position data. The construction process addresses the inherent noise and inconsistencies in position data altitude measurements by implementing a two-step procedure that merges recordings from multiple runs into one global road profile reference.

The vertical position calibration process uses a mathematical relationship to correct altitude variations across multiple data collection runs. The rate of change of vertical position in each lap is calculated using the equations:

$${k}_{l} = ( {Z}_{N , l} - {Z}_{0 , l} ) / {d}_{l} , \qquad ( 3 )$$

$${Z}_{i , l} = {Z}_{0 , l} + {k}_{l} \cdot {d}_{i , l} \qquad ( 3 )$$

Where Z_{N,l} and Z_{0,l} represent the last and first values of the vertical position of lap l respectively, and dₗ represents the total length of each lap l. The vertical position of each pose Z_{i,l} is then updated based on this rate using:

$$i = ∈ [ 0 , N ] \qquad ( 3 )$$

where i represents the index of measurement points within each lap.

The calibration process averages out the altitude gap between each lap to merge different laps' trajectories into one closed-loop track map. This merging operation eliminates inconsistencies between multiple data collection runs and creates a unified reference map that accurately represents the test track geometry and elevation profile.

Referring to FIG. 2, the global environment reference 204 implements an interpolation lookup function that provides real-time pose information based on the ego vehicle's traveled distance. The lookup function follows the relationship:

$${x}_{t} , {y}_{t} , {z}_{t} , {ψ}_{t} , {θ}_{t} = F ( {s}_{t} ) \qquad ( 4 )$$

where the function F takes the longitudinal distance as input and outputs the pose for that distance along the reference trajectory.

The interpolation lookup function uses the ego vehicle's traveled distance data and the processed test track poses map to build a one-dimensional interpolation function that locates the closest pose from the test track based on longitudinal traveled distance. In one configuration, the system uses linear interpolation to estimate pose information between two adjacent reference poses. In another configuration, the system implements Modified Akima cubic Hermite interpolation method to provide smoother and more continuous pose updates between reference points.

The interpolation approach ensures smoothness and continuity of the pose update process by providing accurate spatial coordinates at any point along the reference trajectory. The lookup function enables real-time pose determination without requiring computationally intensive global localization methods, thereby supporting the high refresh rates needed for realistic mixed reality visualization while maintaining spatial accuracy for virtual object placement.

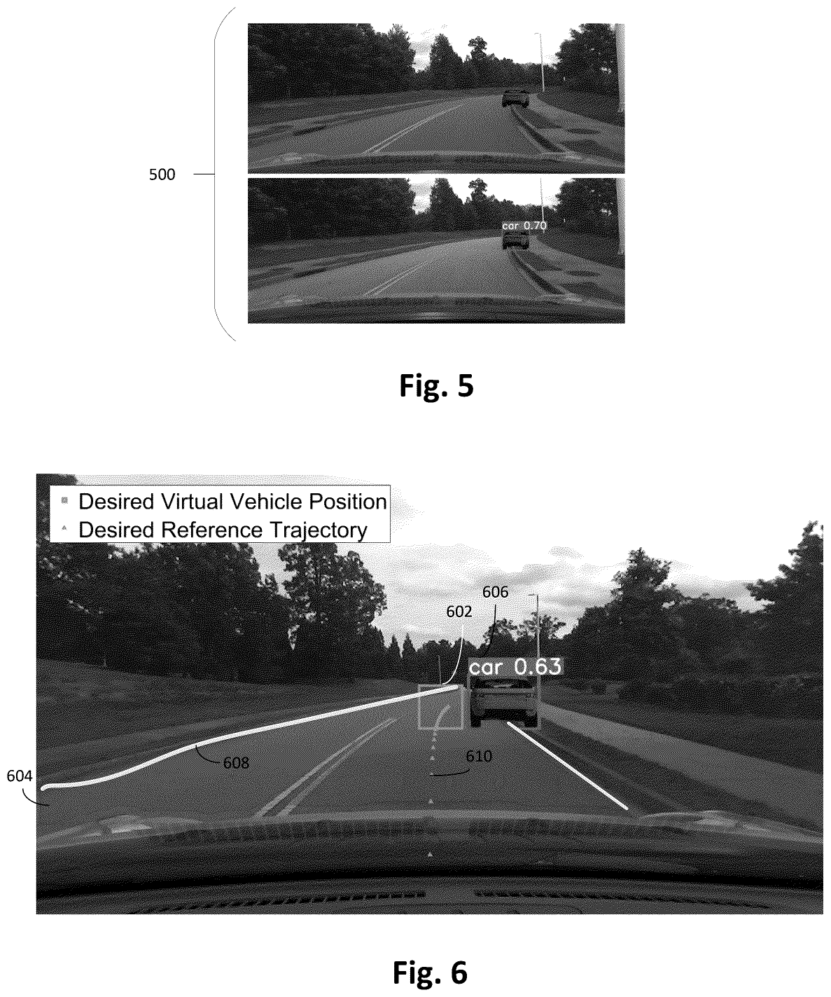

Referring to FIG. 5, an unrealistic virtual traffic display 500 demonstrates how localization errors cause virtual vehicles to appear misaligned with the road surface. The unrealistic virtual traffic display 500 occurs when inaccurate pose information from the ego vehicle results in virtual traffic objects being positioned outside the road boundaries or at incorrect elevations relative to the physical road surface. The unrealistic virtual traffic display 500 compromises the naturalistic perception of human drivers and reduces confidence in the mixed reality environment, leading to delayed or inappropriate driving responses.

The unrealistic virtual traffic display 500 includes a segmented road area 604 that represents the actual drivable surface as detected through computer vision algorithms. A road boundary 608 defines the edges of the segmented road area 604 and provides reference points for determining correct virtual object placement. A detected bounding box of virtual vehicle 606 shows the actual position where the virtual vehicle appears in the mixed reality display, while a desired bounding box of virtual vehicle 602 indicates where the virtual vehicle should be positioned to maintain realistic spatial relationships with the road surface.

The local object pose correction 206 addresses these positioning errors by implementing a real-time virtual object localization and correction algorithm that integrates vehicle sensor data to enhance mixed reality accuracy and stability. The correction algorithm estimates pixel error between desired and displayed virtual objects and calculates required reference modifications based on pixel errors to restore proper virtual object positioning.

Referring to FIG. 6, a trajectory correction example 600 illustrates the systematic approach to correcting virtual vehicle positioning through pixel-based analysis and coordinate adjustment. The trajectory correction example 600 shows the relationship between the desired bounding box of virtual vehicle 602, the segmented road area 604, the detected bounding box of virtual vehicle 606, the road boundary 608, and a desired reference trajectory 610 that guides proper virtual object placement.

The desired reference trajectory 610 represents the correct path along which virtual vehicles should be positioned to maintain realistic spatial relationships with the road surface and the ego vehicle. The desired reference trajectory 610 follows the center line of the driving lane and provides the target positioning reference for virtual object correction algorithms.

The correction process can use a real-time object detection model, sometimes described as a “You Only Look Once” (YOLO) system that can include computer vision algorithms. Using these system provide a powerful and flexible architecture that balances speed and accuracy beyond basic object detection. YOLO can include tasks like image classification, instance segmentation, and pose estimation. The system can also use a segmented anything system (SAM) that can include artificial intelligence (AI) model which can identify and segment objects in an image. These system can assist in the computer vision and can include a promptable interface to perform segmentation tasks on images and videos. In one embodiment theses systems can include the YOLO v8 and Meta SAM models for mixed reality traffic image processing tasks including real-time road segmentation and virtual object detection. YOLO system can perform efficient real-time road segmentation and object detection while SAM systems can creates segmentation labeling for training and validation data. The computer vision algorithms output road segmentation regions and virtual vehicle detection boxes that provide the spatial reference data needed for position correction calculations.

In one embodiment, the road edge pixel set determination follows the relationship defined in:

$$L \{ {u}^{edges} , {v}^{edges} \} = \{ ( u , v ) \vert v ∈ [ {v}_{B , j}^{box} - ε , {v}_{B , j}^{box} + ε ] , ( u , v ) ⊂ S \{ {u}^{road} , {v}^{road} \} \} \qquad ( 5 )$$

where L{u^{edges}, v^{edges}} represents a subset of the segmented road pixel set S{u \hat{ }road, v \hat{ }road} with vertical pixel values close to the rear axle of the detected virtual vehicle's bounding box. The parameter ε defines the tolerance range for pixel selection, and the subscripts B and j represent bottom and left/right positions respectively.

The lateral position correction process implements a two-step calculation using the following representations. The target lateral position can be determined using:

$$\{ \begin{matrix}{u}_{target}^{lateral} = ω \cdot {u}_{R}^{edges} + ( 1 - ω ) \cdot {u}_{L}^{edges} \\ d u = \frac{{u}_{B , L}^{box} + {u}_{B , R}^{box}}{2} - {u}_{target}^{lateral}\end{matrix} \qquad ( 6 )$$

$$where ( {u}_{L}^{edges} , {v}_{L}^{edges} ) and ( {u}_{R}^{edges} , {v}_{R}^{edges} )$$

represent the left and right edges of the segmented road section. Parameter ω can be adjustable to properly locate the desired lateral position of the front vehicle to the center of the desired lane. To improve the smoothness and frequency of virtual objects' correction, the system can use a Kalman filter(KF) to the trajectory correction process. The KF's prediction step of the lateral trajectory correction is shown

$$= + \frac{{x}_{t}^{virtual}}{f} \cdot {du}_{t} \qquad ( 7 )$$

where dy represents the changes in the reference trajectory's lateral position in the vehicle frame. The lateral correction inputs can be are calculated from the horizontal difference in Eqn. (6b). The KF's measurement update process is shown in Eqn. (8).

$$= + {K}_{t}^{y} \cdot ( - ) \qquad ( 8 )$$

The vertical position correction addresses errors where virtual objects appear in the air or beneath the ground surface due to pitch noise when placing virtual traffic in the ego vehicle coordinate system. The vertical correction process uses computer readable instructions represented formulaically below to identify the target road section and calculate the required vertical adjustment.

$$\{ \begin{matrix}( {u}_{target} , {v}_{target} ) = \{ ( {u}_{edges} , {v}_{edges} ) \vert {u}_{R}^{edges} - {u}_{L}^{edges} ∈ \\ [ δ ∈ ( {u}_{B , R}^{box} - {u}_{B , L}^{box} ) - ϵ , δ \cdot ( {u}_{B , R}^{box} - {u}_{B , L}^{box} ) + ϵ ] , \\ {v}_{R}^{e d g e s} = {v}_{L}^{e d g e s} , ( u , v ) ∈ S \{ u , v \} \} \\ d v = {v}_{target} - {v}_{B , j}^{box}\end{matrix} \qquad ( 9 )$$

$$where {u}_{B , L}^{box} and {u}_{B , R}^{box}$$

represent the lateral pixel values of the detected virtual vehicle's left and right bounding box, δ represents the ratio between measured road width and car width,

$${u}_{L}^{edges} and {u}_{R}^{edges}$$

represent the lateral pixel values of the left and right bounding lines of the segmented road area, and (u_{target}, v_{target}) represents the target road section for inserting a virtual vehicle.

The vertical correction offset can be represented using:

$$\hat{d} {θθ}_{t}^{-} = \hat{d} {θ}_{t - 1} + \frac{1}{f} \cdot {dv}_{t} \qquad ( 10 )$$

where f represents the monocular camera's focal length. The prediction in put dvₜ is calculated using computer readable instructions for implementing the process:

$$\hat{d} {θ}_{t} = \hat{d} {θ}_{t - 1} + {K}_{t}^{θ} \cdot ( \hat{d} {θ}_{t}^{-} - \hat{d} {θ}_{t - 1} ) where {K}_{t}^{θ} \qquad ( 11 )$$

represents the latest Kalman gain of pitch correction.

With continued reference to FIGS. 5 and 6, the local object pose correction 206 incorporates Kalman filters to enhance the smoothness and frequency of virtual objects' correction processes. The Kalman filter implementation addresses the temporal discontinuities that can occur during real-time position corrections and provides stable, continuous updates to virtual traffic object positioning within the mixed reality environment.

The lateral trajectory correction implements a Kalman filter prediction step that estimates future lateral position changes based on current correction inputs and virtual object positioning.

The filters provide temporal continuity by incorporating previous correction states into current position updates, reducing visual artifacts and maintaining realistic motion characteristics for virtual traffic objects within the mixed reality environment.

The frequency enhancement achieved through the Kalman filter approach enables higher update rates for virtual object positioning corrections without introducing instability or oscillatory behavior. The filters process correction inputs at rates that exceed the base sensor update frequencies, providing continuous position refinement that maintains accurate alignment between virtual traffic objects and the physical road surface represented by the segmented road area 604 and road boundary 608 references.

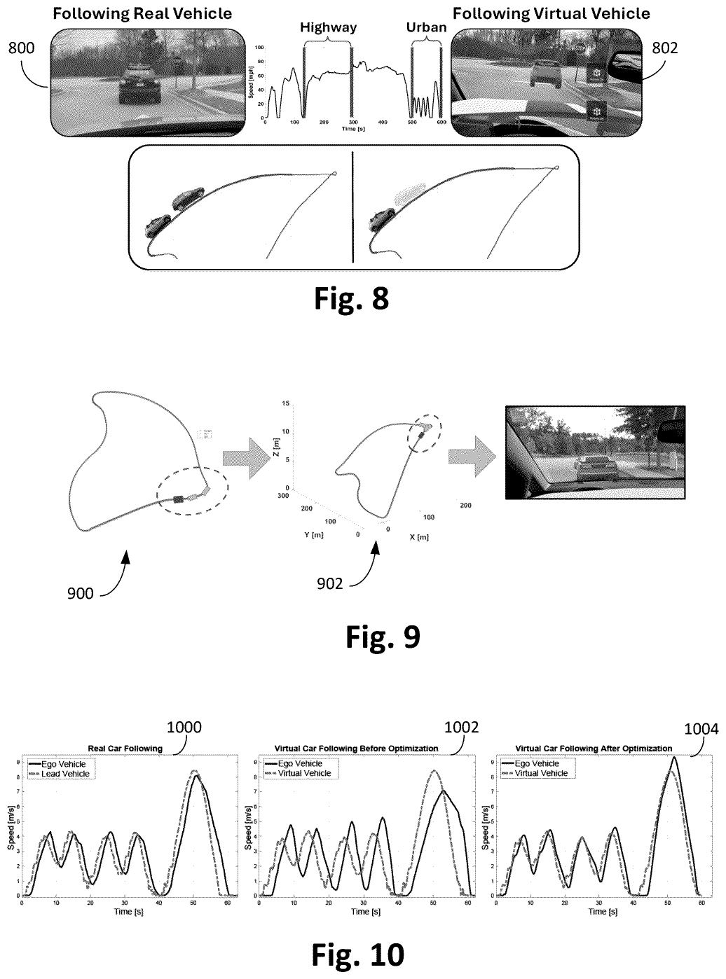

Referring to FIG. 8, the traffic pose update procedure enables enhanced frame rate performance through systematic filter implementation for both virtual and ego vehicle positioning. A travel data 900 component collects and processes positioning information from multiple sensor sources to support high-frequency pose updates. The travel data 900 includes longitudinal distance measurements, velocity data, and acceleration information that forms the foundation for predictive filtering algorithms.

A travel data closest pose 902 component determines the most accurate spatial reference point along the predetermined trajectory based on the current vehicle position and motion state. The travel data closest pose 902 uses interpolation algorithms to identify the optimal reference pose from the preprocessed road profile, ensuring that virtual traffic objects maintain accurate spatial relationships with the physical environment during high-frequency updates.

The virtual vehicle pose prediction implements a state-space update function that processes traffic information from the traffic microsimulation 202 to maintain accurate positioning at enhanced frame rates. The virtual vehicles' poses are selected from the global pose map interpolation output based on estimated traveled distance as input. The virtual objects' information consists of static parameters including two-dimensional position data in frenet coordinates and vehicle heading with respect to the center lane of the road along with dynamic parameters including vehicle longitudinal velocity and vehicle longitudinal acceleration data.

The virtual vehicle state-space update follows:

$$( \begin{matrix}{s}_{t + 1}^{traffic} \\ {v}_{t + 1}^{traffic}\end{matrix} ) = [ \begin{matrix}1 & dt \\ 0 & 1\end{matrix} ] \cdot ( \begin{matrix}{s}_{t}^{traffic} \\ {v}_{t}^{traffic}\end{matrix} ) + [ \begin{matrix}0 \\ dt\end{matrix} ] \cdot {a}_{i}^{traffic} \qquad ( 12 )$$

represents the longitudinal distance travelled and

$${v}_{c}^{t r a f f i c}$$

represents the longitudinal speed.

$${a}_{i}^{t ⌜ a f f i c}$$

is the latest acceleration command received from the traffic microsimulation. represents the latest acceleration command received from the traffic microsimulation 202. The state transition matrix incorporates the time step dt to predict future position and velocity states based on current motion parameters and acceleration inputs from the simulation environment.

The measurement update process for virtual vehicles uses a two-dimensional identity matrix as the observation matrix H, with state measurements consisting of the latest longitudinal distance and velocity from the traffic microsimulation module 202. The measurement values are updated when new microsimulation information becomes available, enabling the Kalman filter to correct predicted states with actual simulation data and maintain synchronization between virtual traffic objects and the simulation environment.

In one embodiment, the ego vehicle pose prediction addresses the different update frequencies between position data at 10 Hz and onboard IMU data at above 100 Hz through integrated Kalman filtering. The ego vehicle Kalman filter uses IMU data as input and position signals as measurements to achieve enhanced frame rate performance while maintaining positioning accuracy. The longitudinal traveled distance and velocity estimation incorporates both high-frequency IMU acceleration data and lower-frequency but more accurate position position references.

In one embodiment, the system can include local reference trajectory correction process data: methodology that includes: the virtual pose in ego vehicle coordinate:

$$\{ {x}_{\check{c}}^{i r l u a 1} , {y}_{{\check{c}}^{i r t u a 1}} , {z}_{\check{c}}^{i r l u a 1} \} .$$

The local reference trajectory: {xₜ, yₜ, zₜ, αₜ, θₜ, γₜ} can be included. The system can include an initialization step that includes a mixed reality captured image p(Rⁿ, Gⁿ, Bⁿ) step. The system can provide a local reference trajectory correction update: {dθ, dy} that can be expressed with the following steps:

```
  while (Simulation Running) do
    Augmented realty captured image processing
      Capture Mixed Reality Image: pᵢ(Rⁿ, Gⁿ, Bⁿ)
      Receive current virtual vehicle pose in ego vehicle coordinate:
$( {x}_{t}^{virtual} , {y}_{t}^{virtual} , {z}_{t}^{virtual} )$
      YOLO Detection and Segmentation:
      $Virtual vehicle detection Box : \{ {u}_{i , j}^{b o x} , {v}_{i , j}^{b o x} \} ← Ψ ( {p}_{i} ( {R}^{n} , {G}^{n} , {B}^{n} ) )$
      $Road region segmentation : S \{ {u}^{road} , {v}^{road} \} ← Ψ ( {p}_{i} ( {R}^{n} , {G}^{n} , {B}^{n} ) )$
      $if \{ {u}_{i , j}^{b o x} , {v}_{i , j}^{b o x} \} and S \{ {u}^{road} , {v}^{road} \} then L \{ {u}^{edges} , {v}^{edges} \} ← S \{ {u}^{road} , {v}^{road} \}$
        Check if the reference trajectory needs correction
        if Incorrect virtual object pose detected then
          du ← Eqn. (5), Eqn. (6)
          dv ← Eqn. (9)
        Else
      du = 0
      dv = 0
      Kalman filter prediction update can be represented with the following:
      if t = 0 then
        \hat{d}yyₜ = 0
        \hat{d}θtₜ = 0
        t = t +1
      end
      $\hat{{dy}_{t}^{-}} = \hat{{dy}_{t - 1}} + du \cdot \frac{{x}_{t}^{virtual}}{f}$
      ${\hat{d θθ}}_{t}^{-} = {\hat{d θθ}}_{t} + \frac{d v}{f}$
      ${P}_{t}^{y -} = {P}_{t - 1}^{y} + {Q}_{y}$
      ${P}_{t}^{θ -} = {P}_{t - 1}^{θ} + {Q}_{θ}$
      Kalman filter measurement update can be represented:
      ${K}_{t}^{y} = {P}_{t}^{y -} \cdot {( {P}_{t}^{y -} + {R}_{y} )}^{- 1}$
      ${K}_{t}^{θ} = {P}_{t}^{θ -} \cdot {( {P}_{t}^{θ -} + {R}_{θ} )}^{- 1}$
      $\hat{{dy}_{t}} = \hat{{dy}_{t - 1}} + {K}_{t}^{y} \cdot ( d {\hat{y}}_{t - 1}^{-} - \hat{{dy}_{t - 1}} )$
      ${\hat{d θθ}}_{t} = {\hat{d θθ}}_{t - 1} + {K}_{t}^{θ} \cdot ( {\hat{d θθ}}_{t}^{-} - {\hat{d θθ}}_{t - 1} )$
      ${P}_{t}^{y} = ( 1 - {K}_{t} ) \cdot {P}_{t}^{y -}$
      ${P}_{t}^{θ} = ( 1 - {K}_{t} ) \cdot {P}_{t}^{θ -}$
      Update timestep for next loop can be represented as”:
      t = t + 1
      end
    end
  end
```

Between two position data and pose information updates, the distance traveled sₜ and ego vehicle velocity vₜ have to be estimated using the acceleration information αₜ and road pitch angle θₜ as shown:

$$\{ \begin{matrix}{a}_{c}^{e g o} = {a}_{c}^{i m u} - g ⋅ sin ( {θ}_{c} ) \\ Matrix = Matrix . Matrix + Matrix . a e c g o \\ {ψ}_{c ′}^{e g o} ′ {θ}_{c}^{e g o} = F ( {s}_{c}^{e g o} ) \\ {v}_{{C}_{Reject} x} = {v}_{c + I}^{e g o} ⋅ cos ( {ψ}_{c}^{e g o} ) \\ {v}_{{C}_{Reject} y} = {v}_{C + I}^{e g o} ⋅ sin ( {ψ}_{c}^{e g o} ) \\ Matrix = Matrix . Matrix + Matrix . d t\end{matrix} \qquad ( 13 )$$

where the pitch angle θₜ, of ego vehicle at distance

$${s}_{c}^{e g o}$$

Can be obtained using (4). Since raw IMU linear acceleration

$${a}_{c}^{i m u}$$

contains the acceleration from road grade, the system can subtract the road grade acceleration term g·sin (θₜ) from the raw IMU acceleration measurement

$${a}_{c}^{i m u}$$

to obtain longitudinal acceleration

$${a}_{c}^{e g o}$$

Since human drivers can't maintain the exact lateral lane position every time, the system can maintain the 2D planner information

$${x}_{c}^{e g o} {y}_{c}^{e g o}$$

from real-time position data as the ego vehicle's poses instead of selecting poses from the prebuilt map using the ego vehicle's distance

$${s}_{c}^{e g o}$$

In some embodiment to account for low update frequency, the system can use the estimated yaw angle

$$! {ψ}_{c}^{e g o}$$

and speed

$${v}_{c}^{e g o}$$

to estimate

$${x}_{c}^{e g o} {y}_{c}^{e g o}$$

as shown in (13).

The mixed-reality traffic object longitudinal pose update process can be represented as follows:

```
  $Data : 1. Host vehicle pose : {s}_{t}^{e g o} , {v}_{t}^{e g o}$
        $2. Traffic vehicles ’ information : {s}_{t}^{traffic} , {v}_{t}^{traffic} , {a}_{t}^{i m u}$
        3. Pre-processed road reference profile: F(sₜ)
        $4. IMU estimated longitudinal acceleration : {a}_{t}^{i m u}$
  Initialization can be represented as:
  1. Find one pose from road reference profile F that is the nearest to the
current ego vehicle's GNSS position as the starting pose: F(s₀), s₀ = 0
    $2. Initialize virtual traffic pose information : {s}_{t}^{traffic} using the same starting$
pose F(s₀) as traffic origin.
    $3. State - space update function A = [ \begin{matrix}1 & dt \\ 0 & 1\end{matrix} ]$
    $4. Initialize covariance matrix for Kalman filter : {P}_{t}^{ego} , {P}_{t}^{traffic}$
    $5. Observation matrices H = [ \begin{matrix}1 & 0 \\ 0 & 1\end{matrix} ]$
$Result : Virtual traffic pose in mixed reality {headset}^{′} s coordinate : {Y}_{headset , traffic}^{t}$
    while (Simulation Running) do
      Update the virtual objects' longitudinal information
      $( \begin{matrix}{s}_{t + 1}^{traffic} \\ {v}_{t + 1}^{traffic}\end{matrix} ) ← Eqn . 12$
    Update the ego vehicle's longitudinal - State Prediction-
      $( \begin{matrix}{s}_{t + 1}^{ego} \\ {v}_{t + 1}^{ego}\end{matrix} ) ← Eqn . 13$
    Traffic vehicle kalman filter parameters update
    ${p}_{t}^{traffic} = {AP}_{t - 1}^{traffic} {A}^{t} + {Q}_{traffic}$
    ${K}_{t}^{traffic} = {P}_{t}^{traffic -} {{H}^{T} ( {HP}_{t}^{traffic -} {H}^{T} + {R}_{traffic} )}^{- 1}$
    $( \begin{matrix}{s}_{t + 1}^{traffic} \\ {v}_{t + 1}^{traffi}\end{matrix} ) = ( \begin{matrix}{s}_{t}^{traffic} \\ {v}_{t}^{traffic}\end{matrix} ) + {K}_{t}^{traffic} \cdot ( ( \begin{matrix}{s}_{i}^{traffic} \\ {v}_{i}^{traffic}\end{matrix} ) - ( \begin{matrix}{s}_{t}^{traffic} \\ {v}_{t}^{traffic}\end{matrix} ) )$
    Obtain 3D pose in real world using lookup function
    ${z}_{t}^{ego} , {ψ}_{t}^{ego} , {θ}_{t}^{ego} = F ( {s}_{t}^{ego} )$
    ${x}_{t}^{traffic} , {y}_{t}^{traffic} , {z}_{t}^{traffic} , {ψ}_{t}^{traffic} , {θ}_{t}^{traffic} = F ( {s}_{t}^{traffic} )$
    Update estimate covariance
    ${P}_{t}^{ego} = ( I - {K}_{t}^{ego} \cdot H ) \cdot {P}_{t}^{ego -}$
    ${P}_{t}^{traffic} = ( I - {K}_{t}^{traffic} \cdot H ) \cdot {P}_{t}^{traffic -}$
    Transform the virtual objects' pose to ego vehicle coordinate
    ${Y}_{t}^{global , ego} = \{ {x}_{t}^{ego} , {y}_{t}^{ego} , F ( {s}_{t}^{ego} ) \}$
    ${Y}_{t}^{global , traffic} = \{ F ( {s}_{t}^{traffic} ) \}$
    ${Y}_{t}^{global , traffic} = {T}_{tag \to headset} \cdot {T}_{ego \to tag} \cdot {T}_{global \to ego} \cdot ( {Y}_{t}^{global , traffic} - {Y}_{t}^{global , ego} )$
      t = t + 1
end
```

Referring to FIG. 9, the travel data closest pose 902 implements the lookup function relationship to provide real-time pose information based on longitudinal distance measurements. The travel data closest pose 902 uses the ego vehicle's traveled distance data and the processed test track poses map to build the one-dimensional interpolation function that locates the closest pose from the test track based on longitudinal traveled distance, enabling continuous pose updates at frequencies that exceed the base sensor update rates.

Referring to FIG. 10, the enhanced frame rate performance is demonstrated through comparative analysis of vehicle following scenarios. A real vehicle following 1000 plot shows the baseline performance when human drivers follow an actual autonomous vehicle around the test track. The real vehicle following 1000 provides the reference standard for natural human driving behavior and response characteristics that the mixed reality system aims to replicate.

A virtual vehicle following before optimization 1002 plot demonstrates the system performance when using raw sensor inputs without the enhanced frame rate algorithms. The virtual vehicle following before optimization 1002 shows delayed human driver responses and less accurate vehicle following behavior due to low update frequencies and positioning discontinuities that compromise the realism of the mixed reality environment.

A virtual vehicle following after optimization 1004 plot illustrates the improved system performance achieved through the enhanced frame rate Kalman filter implementation. The virtual vehicle following after optimization 1004 demonstrates human driver responses that closely match the real vehicle following 1000 baseline, indicating that the enhanced frame rate algorithms successfully maintain realistic mixed reality visualization and enable natural human driving behavior during virtual traffic interaction scenarios.

The enhanced frame rate implementation achieves 120 Hz update frequency for both ego vehicle and virtual traffic objects' poses while maintaining high localization accuracy through the optimized Kalman filter approach. The 120 Hz update frequency eliminates the motion discontinuities and positioning delays that can compromise human driver confidence and response accuracy in mixed reality environments. The high-frequency updates ensure that virtual traffic objects maintain smooth, continuous motion that matches the natural dynamics of real vehicle interactions, enabling realistic human-vehicle-in-the-loop validation scenarios for autonomous vehicle development and testing.

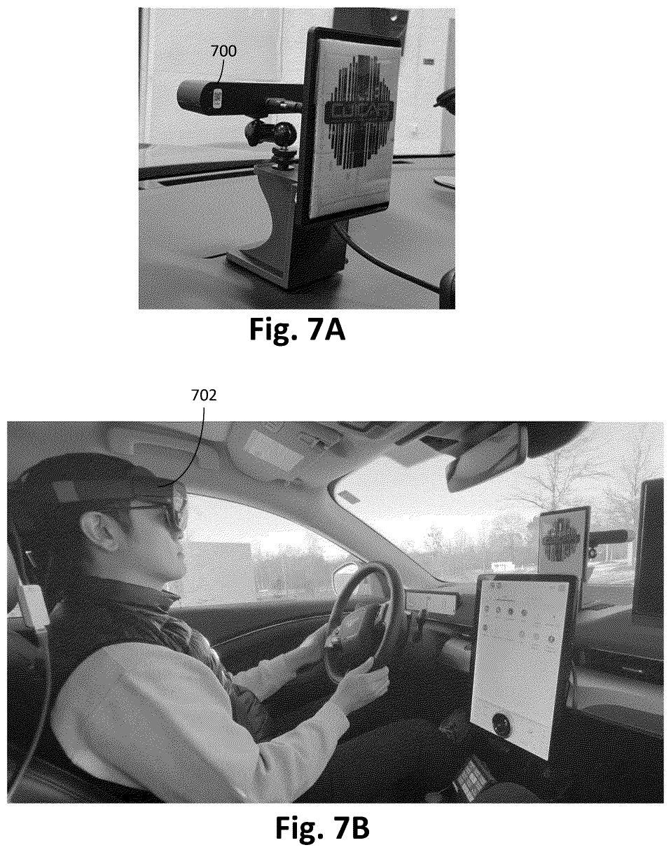

Referring to FIG. 7A, a camera 700 is mounted in a fixed position within the vehicle platform 104 to capture augmented reality images during mixed reality validation operations. The camera 700 serves as a mixed reality image capture device that provides visual input for the local object pose correction 206 algorithms. In one embodiment, the camera 700 is a ZED augmented reality camera that captures simulation images for image processing and enables the correction algorithm to receive RGB image input with virtual objects added to the image frame along with the virtual objects' position and rotation information in the ego vehicle's coordinate system.

The camera 700 maintains a fixed mounting position to facilitate calculation of required local reference trajectory corrections and ensure consistent spatial relationships between the captured images and the vehicle platform 104 coordinate system. The fixed mounting position of the camera 700 eliminates variability in the camera's perspective and enables accurate pixel-based analysis for virtual object positioning corrections within the segmented road area 604 and relative to the road boundary 608.

Referring to FIG. 7B, a mixed reality headset 702 is worn by the driver during on-site human driving test 208 operations to enable interaction with virtual traffic objects while maintaining visual connection to the real-world driving environment. The mixed reality headset 702 uses optical see-through technology that allows users to view the real world directly through a transparent display overlaying virtual content, providing the highest level of reality rendering among existing mixed reality frameworks.

The mixed reality headset 702 differs from video see-through technology, which uses a camera to capture the real world and displays augmented content on top of that video feed. The optical see-through approach of the mixed reality headset 702 enables direct viewing of the physical environment without digital processing delays, maintaining natural visual perception while adding virtual traffic objects to the driver's field of view.

In one configuration, the mixed reality headset 702 is a Microsoft HoloLens 2 device that provides optical see-through mixed reality capabilities with moving platform mode functionality to accommodate vehicle motion during testing operations. The mixed reality headset 702 interfaces with the vision and image bridge 302 through the Vuforia Camera Engine to detect pre-calibrated image tags and obtain transformation matrices between the mixed reality device and the ego vehicle for coordinate alignment.

The mixed reality headset 702 works in conjunction with the camera 700 to enable comprehensive mixed reality validation operations. The camera 700 captures augmented reality images that include both real-world road surfaces and virtual traffic objects, while the mixed reality headset 702 presents the virtual traffic 304 objects to the human driver through optical see-through display technology. The coordination between the camera 700 and the mixed reality headset 702 enables the local object pose correction 206 to analyze pixel differences between desired and actual virtual object positions and apply corrections to maintain realistic spatial relationships.

The mixed reality headset 702 receives corrected pose information from the traffic pose update procedure and renders virtual traffic objects at enhanced frame rates of 120 Hz to ensure smooth, continuous motion that matches natural vehicle dynamics. The optical see-through display of the mixed reality headset 702 overlays virtual content directly onto the driver's real-world view without requiring video processing, eliminating latency that can compromise human driver response accuracy during vehicle following scenarios.

The hardware configuration enables the vehicle-to-human depiction 118 to facilitate realistic interaction between the vehicle platform 104 and human operators through the combined functionality of the camera 700 for image capture and analysis, and the mixed reality headset 702 for virtual object presentation. The camera 700 and mixed reality headset 702 work together to maintain accurate alignment between virtual traffic objects and the physical road environment, supporting the ego vehicle coordinate initialization 200 and enabling precise coordinate transformations between the global environment reference 204 and the driver's visual field.

Referring to FIG. 8, the experimental validation framework compares human driver responses between real and virtual traffic scenarios through systematic testing protocols. A driver follow test actual 800 represents the baseline experimental condition where human drivers follow a real autonomous vehicle around a predetermined test track. The driver follow test actual 800 provides reference data for natural human driving behavior and response characteristics that serve as the validation standard for mixed reality system performance.

A driver follow test virtual 802 represents the experimental condition where human drivers follow virtual autonomous vehicles presented through the mixed reality headset 702 while operating the physical vehicle platform 104. The driver follow test virtual 802 uses the same motion profiles and driving scenarios as the driver follow test actual 800 to enable direct comparison of human driver responses between real and virtual traffic interactions.

The experimental validation operates at testing facilities including the International Transportation Innovation Center (ITIC) Greenville testing facility, which allows single-lane and multi-lane test scenarios for connected and automated vehicles on closed-loop test tracks. The test tracks include altitude changes and sharp corners that provide challenging driving conditions for evaluating the mixed reality system performance under varied geometric and elevation conditions.

The experimental framework implements two distinct driving scenarios to evaluate different aspects of human-vehicle interaction. The highway scenario uses steady speed profiles in straight-line driving conditions to evaluate distance-keeping performance and speed synchronization between human drivers and lead vehicles. The urban scenario incorporates dynamic speed profiles with multiple stop-and-go cycles on twisty and narrower roads with altitude changes to evaluate human driver reactions to close-proximity virtual traffic interactions.

The driver follow test actual 800 and the driver follow test virtual 802 use identical speed profiles selected from the US06 driving cycle and scaled to satisfy test track speed limits. The speed profiles contain accelerate-speed maintaining-stop driving behaviors for highway scenarios and more dynamic patterns with frequent stop-and-go cycles for urban scenarios. The identical speed profile implementation ensures that differences in human driver responses can be attributed to the mixed reality system performance rather than variations in the lead vehicle behavior.

In some testing, the reaction period was the time gap between the front and the ego vehicle operation switch. The reaction data statistics of 10 human drivers are shown in Table I and Table II.

TABLE I

| | | | 95% confidence | |
|---|---|---|---|---|
| Participant | Mean[s] | Std error[s] | Lower bound | Upper bound |

Follow real front vehicle

| | | | | |
|---|---|---|---|---|
| Driver 1 | 0.85 | 0.57 | 0.62 | 1.07 |
| Driver 2 | 0.86 | 0.38 | 0.72 | 0.99 |
| Driver 3 | 0.92 | 0.43 | 0.76 | 1.08 |
| Driver 4 | 0.80 | 0.38 | 0.68 | 0.93 |
| Driver 5 | 0.73 | 0.31 | 0.61 | 0.85 |
| Driver 6 | 0.63 | 0.21 | 0.50 | 0.76 |
| Driver 7 | 0.91 | 0.53 | 0.57 | 1.24 |
| Driver 8 | 0.76 | 0.17 | 0.65 | 0.87 |
| Driver 9 | 0.55 | 0.20 | 0.43 | 0.67 |
| Driver 10 | 0.76 | 0.24 | 0.61 | 0.92 |

Follow holographic virtual front vehicle before optimization

| | | | | |
|---|---|---|---|---|
| Driver 1 | 1.58 | 0.51 | 1.41 | 1.76 |
| Driver 2 | 1.35 | 0.38 | 1.23 | 1.48 |
| Driver 3 | 1.30 | 0.47 | 1.13 | 1.46 |
| Driver 4 | 1.47 | 0.53 | 1.27 | 1.68 |
| Driver 5 | 1.30 | 0.49 | 1.12 | 1.48 |
| Driver 6 | 1.44 | 0.34 | 1.23 | 1.65 |
| Driver 7 | 1.13 | 0.56 | 0.77 | 1.48 |
| Driver 8 | 1.10 | 0.42 | 0.83 | 1.36 |
| Driver 9 | 1.19 | 0.65 | 0.78 | 1.61 |
| Driver 10 | 1.41 | 0.33 | 1.19 | 1.62 |

Follow holographic virtual front vehicle after optimization

| | | | | |
|---|---|---|---|---|
| Driver 1 | 1.11 | 0.48 | 0.93 | 1.28 |
| Driver 2 | 1.27 | 0.53 | 1.07 | 1.47 |
| Driver 3 | 0.91 | 0.41 | 0.77 | 1.06 |
| Driver 4 | 0.90 | 0.48 | 0.71 | 1.09 |
| Driver 5 | 0.96 | 0.55 | 0.76 | 1.16 |
| Driver 6 | 0.86 | 0.35 | 0.64 | 1.09 |
| Driver 7 | 0.92 | 0.17 | 0.81 | 1.03 |
| Driver 8 | 0.66 | 0.49 | 0.35 | 0.97 |
| Driver 9 | 0.57 | 0.37 | 0.33 | 0.81 |
| Driver 10 | 0.85 | 0.37 | 0.61 | 1.08 |

TABLE II

| | Before Optimization | | | After Optimization | | |
|---|---|---|---|---|---|---|
| Participant | t | p | dtw | t | p | dtw |
| Driver 1 | 5.35 | 1.42e−6 | 206.13 | −1.86 | 0.07 | 97.62 |
| Driver 2 | 5.45 | 7.88e−7 | 212.94 | −3.52 | 0.0008 | 103.01 |
| Driver 3 | 3.32 | 0.0015 | 137.86 | 0.06 | 0.95 | 74.02 |
| Driver 4 | 5.99 | 1.06e−7 | 280.85 | −0.93 | 0.36 | 134.35 |
| Driver 5 | 5.27 | 2.31e−6 | 203.05 | −1.94 | 0.057 | 118.68 |
| Driver 6 | 4.68 | 0.02 | 110.61 | 1.31 | 0.14 | 59.9 |
| Driver 7 | 0.65 | 0.05 | 220.82 | 0.04 | 0.11 | 92.21 |
| Driver 8 | 1.81 | 0.11 | 122.71 | −0.47 | 0.41 | 76.97 |
| Driver 9 | 2.41 | 0.07 | 149.15 | 0.11 | 0.48 | 106.64 |
| Driver 10 | 3.53 | 0.0094 | 244.64 | 0.42 | 0.41 | 173.27 |

Referring to FIG. 9, the travel data 900 analysis demonstrates the systematic approach to processing positioning information for accurate virtual object placement along the reference trajectory. The travel data 900 includes longitudinal distance measurements, velocity data, acceleration information, and spatial coordinates collected from multiple sensor sources during experimental validation operations.

The travel data closest pose 902 represents the processed output that identifies the most accurate spatial reference point along the predetermined trajectory based on current vehicle position and motion state. The travel data closest pose 902 uses the interpolation lookup function F(s_t) from the global environment reference 204 to determine optimal reference poses from the preprocessed road profile, ensuring that virtual traffic objects maintain accurate spatial relationships with the physical environment during experimental validation.

The travel data 900 processing incorporates the enhanced frame rate Kalman filter algorithms to provide continuous pose updates at frequencies that exceed base sensor update rates. The processing combines high-frequency IMU data at above 100 Hz with lower-frequency position position data at 10 Hz to generate the travel data closest pose 902 at 120 Hz update rates. The enhanced frequency processing eliminates motion discontinuities and positioning delays that can compromise human driver confidence during the driver follow test virtual 802 operations.

The travel data closest pose 902 determination uses the one-dimensional interpolation function that takes longitudinal distance as input and outputs comprehensive pose information including three-dimensional position coordinates and orientation angles corresponding to that distance along the reference trajectory. The interpolation approach uses Modified Akima cubic Hermite interpolation method to provide smooth and continuous pose updates between reference points, supporting realistic virtual object motion during experimental validation scenarios.

Referring to FIG. 10, the comparative speed profile results demonstrate the effectiveness of the enhanced frame rate algorithms through systematic analysis of human driver responses across different system configurations. The real vehicle following 1000 plot shows the speed profiles of both the ego vehicle and the preceding vehicle when human drivers follow an actual autonomous vehicle during the driver follow test actual 800. The real vehicle following 1000 provides the baseline performance standard that represents natural human driving behavior and response characteristics.

The virtual vehicle following before optimization 1002 plot displays the speed profiles when human drivers follow virtual vehicles using raw sensor inputs without enhanced frame rate algorithms during initial implementations of the driver follow test virtual 802. The virtual vehicle following before optimization 1002 shows delayed human driver responses and less accurate vehicle following behavior due to low update frequencies from direct use of position pose data at 10 Hz and microsimulation information without Kalman filter processing.

The virtual vehicle following after optimization 1004 plot illustrates the improved system performance achieved through implementation of the enhanced frame rate Kalman filter algorithms and the local object pose correction 206 during optimized versions of the driver follow test virtual 802. The virtual vehicle following after optimization 1004 demonstrates human driver responses that closely match the real vehicle following 1000 baseline performance.

The comparative analysis shows that the virtual vehicle following before optimization 1002 exhibits significant reaction delays and more aggressive driving actions as human drivers compensate for late reactions to virtual vehicle motion. The low update frequency causes virtual vehicles to appear less responsive to human driver control inputs, reducing driver confidence and leading to delayed pedal reactions during acceleration and deceleration cycles.

The virtual vehicle following after optimization 1004 eliminates these performance limitations through the 120 Hz update frequency implementation and real-time pose correction algorithms. The optimized system enables virtual vehicles to appear more responsive to human driver control inputs, providing driver confidence levels that match those observed during the real vehicle following 1000 scenarios. The speed profile matching between the virtual vehicle following after optimization 1004 and the real vehicle following 1000 validates that the enhanced mixed reality system successfully replicates natural human driving behavior during virtual traffic interactions.

The experimental validation results demonstrate that the optimized mixed reality system achieves reaction time improvements of more than 0.5 seconds compared to unoptimized implementations. The reaction time analysis measures the time gap between lead vehicle operation switches and human driver pedal responses during close car-following scenarios that mimic city-style driving conditions. The improved reaction times in the virtual vehicle following after optimization 1004 approach the performance levels observed in the real vehicle following 1000, confirming that the enhanced frame rate and pose correction algorithms successfully maintain realistic mixed reality visualization for human-vehicle-in-the-loop validation applications.

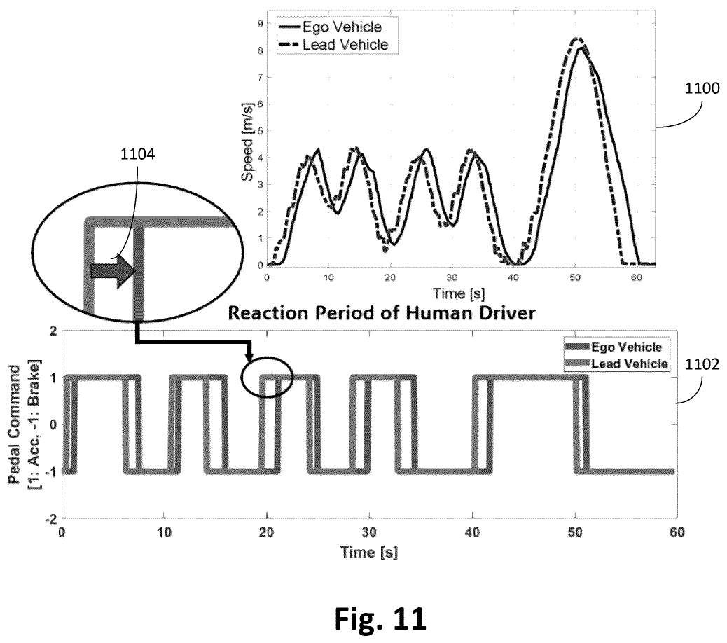

Referring to FIG. 11, the driver reaction time measurement system captures the temporal relationship between lead vehicle motion and human driver responses through systematic analysis of acceleration patterns and pedal inputs. A vehicle acceleration and deceleration 1100 signal represents the speed change profile of the lead vehicle during car-following scenarios, showing the acceleration and deceleration cycles that the human driver must respond to during the driver follow test actual 800 and the driver follow test virtual 802 operations.

A pedal command 1102 signal represents the human driver's throttle and brake inputs in response to the vehicle acceleration and deceleration 1100 patterns. The pedal command 1102 captures the actual control inputs applied by human drivers as the drivers attempt to maintain appropriate following distance and speed synchronization with the lead vehicle during mixed reality validation scenarios.

A reaction gap 1104 represents the temporal offset between the vehicle acceleration and deceleration 1100 signal and the corresponding pedal command 1102 response. The reaction gap 1104 quantifies the time delay between when the lead vehicle initiates a speed change and when the human driver responds with appropriate pedal inputs to maintain proper car-following behavior.

The reaction gap 1104 measurement enables quantitative assessment of human driver response characteristics across different system configurations. During the real vehicle following 1000 scenarios, the reaction gap 1104 establishes baseline human response times that represent natural driving behavior when following actual vehicles. The baseline reaction gap 1104 measurements provide the reference standard for evaluating mixed reality system performance.

The reaction gap 1104 analysis during the virtual vehicle following before optimization 1002 scenarios reveals significantly longer response delays compared to the baseline measurements. The extended reaction gap 1104 occurs due to low update frequencies and positioning discontinuities that reduce human driver confidence in virtual vehicle motion. The delayed responses manifest as longer reaction gap 1104 periods where human drivers hesitate before applying pedal command 1102 inputs in response to virtual vehicle acceleration and deceleration 1100 changes.

The reaction gap 1104 measurements during the virtual vehicle following after optimization 1004 scenarios demonstrate substantial improvement in human driver response times. The optimized system reduces the reaction gap 1104 to levels that closely match the baseline measurements from the real vehicle following 1000 scenarios. The improved reaction gap 1104 performance results from the enhanced frame rate algorithms and the local object pose correction 206 that maintain realistic virtual vehicle motion and positioning accuracy.

The reaction gap 1104 data collection occurs during close car-following scenarios that mimic city-style driving conditions where human drivers are encouraged to follow the lead vehicle closely at low speeds. These scenarios maximize the sensitivity of the reaction gap 1104 measurements to system performance variations, as communication delays, frame rate limitations, and localization noise can significantly affect human response times during close-proximity interactions.

The pedal command 1102 analysis captures both acceleration and deceleration responses to provide comprehensive assessment of human driver behavior across different driving maneuvers. The acceleration responses in the pedal command 1102 data show how quickly human drivers apply throttle inputs when the lead vehicle accelerates, while the deceleration responses demonstrate braking reaction times when the lead vehicle reduces speed.

The vehicle acceleration and deceleration 1100 patterns are designed to include multiple transition cycles between acceleration and deceleration states to generate sufficient data points for statistical analysis of the reaction gap 1104 measurements. The cyclic patterns enable repeated measurement of human driver responses under consistent conditions, supporting reliable comparison between the real vehicle following 1000, the virtual vehicle following before optimization 1002, and the virtual vehicle following after optimization 1004 scenarios.

The reaction gap 1104 measurements validate that the enhanced mixed reality system successfully replicates the temporal characteristics of real vehicle interactions. The reduction in the reaction gap 1104 from the virtual vehicle following before optimization 1002 to the virtual vehicle following after optimization 1004 demonstrates that the 120 Hz update frequency and real-time pose correction algorithms eliminate the response delays that can compromise human driver performance during mixed reality validation operations.

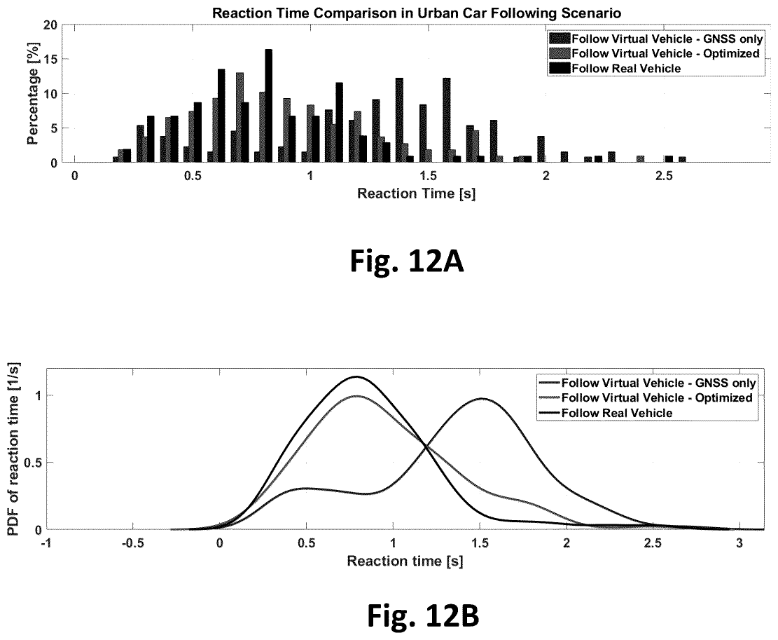

Referring to FIG. 12A, a reaction time percentage 1200 displays the statistical distribution of human driver response times across three distinct experimental conditions during car-following validation scenarios. The reaction time percentage 1200 quantifies the frequency distribution of reaction times measured in seconds, showing how often specific response delays occur under different system configurations during the driver follow test actual 800 and the driver follow test virtual 802 operations.

The reaction time percentage 1200 data demonstrates three distinct response patterns corresponding to different experimental conditions. The first condition represents human drivers following a real vehicle during the real vehicle following 1000 scenarios, establishing baseline reaction time distributions that reflect natural human driving behavior. The baseline reaction time percentage 1200 shows response times typically ranging from 0.5 to 1.5 seconds, with the majority of responses occurring within the 0.7 to 1.0 second range.

The second condition in the reaction time percentage 1200 represents human drivers following virtual vehicles using raw position data without optimization algorithms during the virtual vehicle following before optimization 1002 scenarios. The unoptimized reaction time percentage 1200 shows significantly longer response delays, with reaction times extending from 1.0 to 2.5 seconds and peak frequencies occurring in the 1.3 to 1.8 second range. The extended reaction times result from low update frequencies and positioning discontinuities that reduce human driver confidence in virtual vehicle motion.

The third condition in the reaction time percentage 1200 represents human drivers following virtual vehicles with the enhanced frame rate algorithms and the local object pose correction 206 during the virtual vehicle following after optimization 1004 scenarios. The optimized reaction time percentage 1200 demonstrates substantial improvement in human driver response times, with reaction time distributions that closely match the baseline real vehicle following patterns.

Referring to FIG. 12B, a reaction time probability density function 1202 provides detailed statistical analysis of the reaction time distributions through continuous probability density curves for each experimental condition. The reaction time probability density function 1202 enables precise quantitative comparison of human driver response characteristics across the three system configurations by showing the probability density of specific reaction times occurring within the measured data sets.

The reaction time probability density function 1202 for the real vehicle following 1000 condition establishes the reference probability distribution that represents natural human driving behavior. The baseline reaction time probability density function 1202 shows a concentrated probability density peak around 0.8 seconds, with the distribution tapering off at shorter and longer reaction times. The baseline distribution demonstrates consistent human driver responses with relatively low variability in reaction times.

The reaction time probability density function 1202 for the virtual vehicle following before optimization 1002 condition shows a shifted probability distribution with peak density occurring around 1.4 seconds. The unoptimized reaction time probability density function 1202 exhibits broader distribution spread and higher variability compared to the baseline, indicating less consistent human driver responses when following virtual vehicles without enhanced frame rate processing.

The reaction time probability density function 1202 for the virtual vehicle following after optimization 1004 condition demonstrates significant improvement in human driver response characteristics. The optimized reaction time probability density function 1202 shows a probability density peak that closely aligns with the baseline real vehicle following distribution, with peak density occurring around 0.9 seconds and similar distribution spread characteristics.

The comparative analysis between the reaction time probability density function 1202 curves quantifies the performance improvement achieved through the enhanced mixed reality system implementation. The optimized system reduces mean reaction times by more than 0.5 seconds compared to the unoptimized virtual vehicle following before optimization 1002 condition. The 0.5 second improvement represents a substantial enhancement in human driver response performance that approaches the natural response characteristics observed during the real vehicle following 1000 scenarios.

The reaction time probability density function 1202 analysis validates that the enhanced frame rate algorithms and the local object pose correction 206 successfully eliminate the response delays that compromise human driver performance during mixed reality validation operations. The probability density curves demonstrate that the optimized system maintains reaction time distributions that closely match natural human driving behavior, confirming that the 120 Hz update frequency and real-time pose correction algorithms provide sufficient temporal resolution and positioning accuracy for realistic human-vehicle-in-the-loop validation scenarios.

The statistical significance of the reaction time improvement is demonstrated through the shift in the reaction time probability density function 1202 peak positions and the reduction in distribution variance. The optimized system not only reduces mean reaction times but also decreases the variability in human driver responses, indicating improved consistency and reliability in virtual traffic interactions. The reduced variability in the reaction time probability density function 1202 suggests that human drivers develop greater confidence in virtual vehicle motion when the enhanced mixed reality system maintains realistic temporal and spatial characteristics.

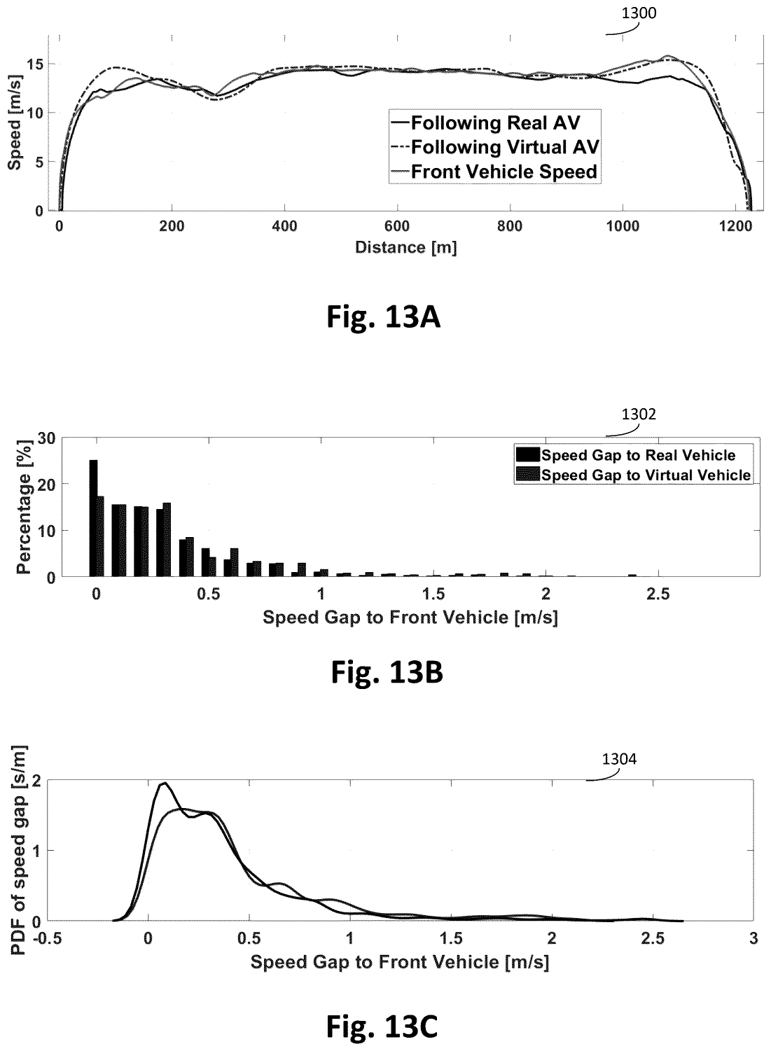

Referring to FIG. 13A, a speed when following real and virtual vehicles 1300 displays velocity profiles measured over distance during highway-style car-following scenarios that compare human driver performance between the driver follow test actual 800 and the driver follow test virtual 802 operations. The speed when following real and virtual vehicles 1300 shows the temporal relationship between ego vehicle speed and lead vehicle speed across different experimental conditions, demonstrating how closely human drivers maintain speed synchronization during vehicle following tasks.

The speed when following real and virtual vehicles 1300 data captures velocity measurements during highway scenarios that use steady speed profiles in straight-line driving conditions to evaluate distance-keeping performance and speed synchronization capabilities. The highway scenarios implement speed profiles selected from the US06 driving cycle and scaled to satisfy test track speed limits, containing accelerate-speed maintaining-stop driving behaviors that provide consistent evaluation conditions across real and virtual traffic interactions.

The speed when following real and virtual vehicles 1300 demonstrates that human drivers maintain similar velocity tracking performance when following virtual vehicles through the mixed reality headset 702 compared to following actual vehicles during baseline testing. The velocity profiles show close alignment between ego vehicle speed and lead vehicle speed during steady-state driving periods, indicating that the enhanced frame rate algorithms and the local object pose correction 206 enable realistic speed perception and appropriate human driver responses during virtual traffic interactions.

Referring to FIG. 13B, a speed gap percentage 1302 quantifies the frequency distribution of speed differences between ego vehicles and lead vehicles during highway car-following scenarios across different experimental conditions. The speed gap percentage 1302 measures the percentage occurrence of specific speed difference magnitudes, providing statistical analysis of how consistently human drivers maintain appropriate speed relationships with lead vehicles during the real vehicle following 1000 and the virtual vehicle following after optimization 1004 scenarios.

The speed gap percentage 1302 analysis focuses on speed-maintaining periods between 40 and 85 seconds of the test scenarios where lead vehicles maintain steady velocities and human drivers demonstrate distance-keeping behavior. During these steady-state periods, the speed gap percentage 1302 shows that both real and virtual traffic following scenarios maintain speed differences within 1.5 m/s, indicating consistent human driver performance across both experimental conditions.

The speed gap percentage 1302 data demonstrates that human drivers achieve similar speed synchronization performance when following virtual vehicles compared to real vehicles during highway scenarios. The frequency distributions show comparable patterns between real and virtual traffic interactions, with the majority of speed differences occurring within the 0.5 to 1.0 m/s range for both experimental conditions. The similar speed gap percentage 1302 patterns validate that the enhanced mixed reality system maintains realistic speed perception and enables natural human driving behavior during highway-style validation scenarios.

Referring to FIG. 13C, a speed gap probability density function 1304 provides detailed statistical analysis of speed difference distributions through continuous probability density curves for real and virtual vehicle following scenarios. The speed gap probability density function 1304 enables precise quantitative comparison of human driver speed-keeping performance by showing the probability density of specific speed differences occurring within the measured data sets during highway car-following operations.

The speed gap probability density function 1304 for real vehicle following scenarios establishes the reference probability distribution that represents natural human speed-keeping behavior during the driver follow test actual 800. The baseline speed gap probability density function 1304 shows concentrated probability density around small speed differences, with peak density occurring near zero speed gap and gradual tapering at larger speed differences.

The speed gap probability density function 1304 for virtual vehicle following scenarios demonstrates probability density characteristics that closely match the baseline real vehicle following distribution. The virtual traffic speed gap probability density function 1304 shows similar peak density positioning and distribution spread compared to the real vehicle following reference, indicating that human drivers maintain comparable speed-keeping performance when interacting with virtual traffic objects through the mixed reality headset 702.

The quantitative analysis of the speed gap probability density function 1304 reveals that the average speed gap measures 1.1 m/s when human drivers follow real vehicles during baseline testing scenarios. The corresponding average speed gap measures 1.07 m/s when human drivers follow virtual vehicles using the enhanced mixed reality system with the virtual vehicle following after optimization 1004 algorithms. The 0.03 m/s difference between real and virtual vehicle following represents minimal variation that falls within natural human driving variability ranges.

During speed-maintaining periods specifically, the speed gap probability density function 1304 shows even closer alignment between real and virtual vehicle following performance. The speed difference analysis during steady-state driving periods reveals average speed gaps of 0.35 m/s for real vehicle following and 0.426 m/s for virtual vehicle following. The 0.076 m/s difference during steady-state periods demonstrates that the enhanced mixed reality system maintains highly accurate speed perception and enables natural human speed-keeping behavior during highway validation scenarios.

The speed gap probability density function 1304 validation confirms that the enhanced frame rate algorithms operating at 120 Hz update frequency and the local object pose correction 206 successfully replicate the temporal characteristics of real vehicle speed changes. The close alignment between real and virtual vehicle speed gap distributions demonstrates that virtual traffic objects maintain realistic motion characteristics that enable natural human driver responses during highway-style car-following scenarios.

The statistical analysis through the speed gap probability density function 1304 validates that human drivers develop similar confidence levels and speed-keeping strategies when following virtual vehicles compared to real vehicles. The probability density curves show comparable variance characteristics between real and virtual vehicle following scenarios, indicating consistent human driver behavior and reliable mixed reality system performance during highway validation operations. The speed analysis results confirm that the enhanced mixed reality system provides sufficient temporal resolution and motion fidelity to support realistic human-vehicle-in-the-loop validation for autonomous vehicle development and testing applications.

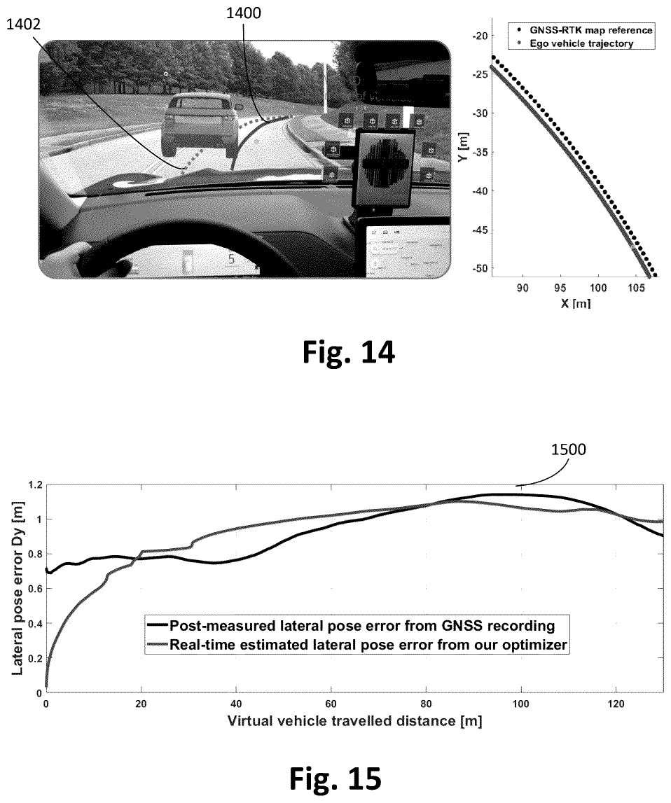

Referring to FIG. 14, an ego vehicle's driving trajectory 1400 represents the actual path traveled by the test vehicle during mixed reality validation operations, recorded through real-time position measurements collected during experimental testing scenarios. The ego vehicle's driving trajectory 1400 captures the precise positioning data that reflects the vehicle's actual movement along the test track during the driver follow test actual 800 and the driver follow test virtual 802 operations.

A preprocessed position pose map 1402 represents the reference trajectory constructed through the road reference construction process described in the global environment reference 204, where multiple position data collection runs are filtered and processed to form a unified road profile reference. The preprocessed position pose map 1402 serves as the ground truth reference for virtual object positioning and coordinate transformations within the mixed reality validation system.

The comparison between the ego vehicle's driving trajectory 1400 and the preprocessed position pose map 1402 reveals systematic positioning discrepancies that occur due to inherent position measurement variations and environmental factors affecting satellite signal reception. The ego vehicle's driving trajectory 1400 shows lateral deviations from the preprocessed position pose map 1402 that demonstrate the positioning challenges encountered during real-time mixed reality operations.

A pose error 1500 quantifies the spatial offset between the ego vehicle's driving trajectory 1400 and the preprocessed position pose map 1402, measuring the lateral displacement that occurs when real-time position measurements differ from the reference trajectory coordinates. The pose error 1500 analysis reveals average lateral offsets of 0.74 meters between the real-time vehicle position and the reference trajectory, indicating substantial positioning discrepancies that can compromise virtual object placement accuracy without correction algorithms.

The pose error 1500 measurements demonstrate consistent lateral displacement patterns that occur throughout the test track, with the ego vehicle's driving trajectory 1400 maintaining a relatively constant offset from the preprocessed position pose map 1402 rather than exhibiting random positioning variations. The systematic nature of the pose error 1500 indicates that the positioning discrepancies result from calibration differences between the real-time position measurements and the preprocessed reference data rather than random measurement noise.

Referring to FIG. 15, the pose error 1500 analysis over time and distance demonstrates the temporal characteristics of position positioning discrepancies during mixed reality validation operations. The pose error 1500 measurements show variations in lateral displacement that correlate with vehicle position along the test track, indicating that positioning accuracy varies with location-specific factors such as satellite geometry and environmental conditions.

The pose error 1500 data collected during experimental validation operations provides the foundation for evaluating the effectiveness of the local object pose correction 206 algorithms in detecting and compensating for position positioning errors. The vision-based correction algorithm uses the pose error 1500 measurements as reference data to validate the accuracy of real-time error detection through computer vision analysis of the segmented road area 604 and the road boundary 608.

The comparison between post-measured lateral pose error from position recording and estimated lateral pose error using the vision-based optimizer demonstrates the effectiveness of the correction algorithm in real-time error detection. The vision-based pose error estimation closely matches the actual pose error 1500 measurements derived from the comparison between the ego vehicle's driving trajectory 1400 and the preprocessed position pose map 1402, validating that the computer vision algorithms can accurately detect positioning discrepancies during mixed reality operations.

The real-time pose error detection enables the local object pose correction 206 to compensate for position positioning errors through pixel-based analysis and coordinate adjustments that maintain accurate virtual object placement relative to the physical road surface. The correction algorithm processes the detected pose error 1500 through the Kalman filter implementation to provide smooth, continuous corrections that eliminate the 0.74 meter average lateral offset without introducing positioning discontinuities.

The pose error 1500 compensation incorporates road grade acceleration correction that subtracts the road grade acceleration term g·sin (θ) from raw IMU acceleration measurement to obtain longitudinal acceleration for ego vehicle pose estimation. The road grade compensation addresses elevation-related positioning errors that can occur when the ego vehicle's driving trajectory 1400 includes altitude changes along the test track, ensuring that the pose error 1500 corrections account for three-dimensional positioning requirements rather than only lateral displacement.

The effectiveness of the pose error 1500 correction is demonstrated through the improved alignment between virtual traffic objects and the physical road surface during mixed reality validation operations. The vision-based correction algorithm eliminates the unrealistic virtual traffic display 500 that occurs when the 0.74 meter lateral offset causes virtual vehicles to appear outside the road boundaries, restoring proper spatial relationships between virtual objects and the segmented road area 604.

The pose error 1500 analysis validates that the enhanced mixed reality system successfully addresses the positioning challenges that can compromise virtual object placement accuracy during real-time operations. The combination of real-time error detection through computer vision analysis and systematic correction through Kalman filter processing enables the system to maintain accurate virtual traffic positioning despite inherent position measurement variations and environmental factors that affect satellite-based positioning systems.

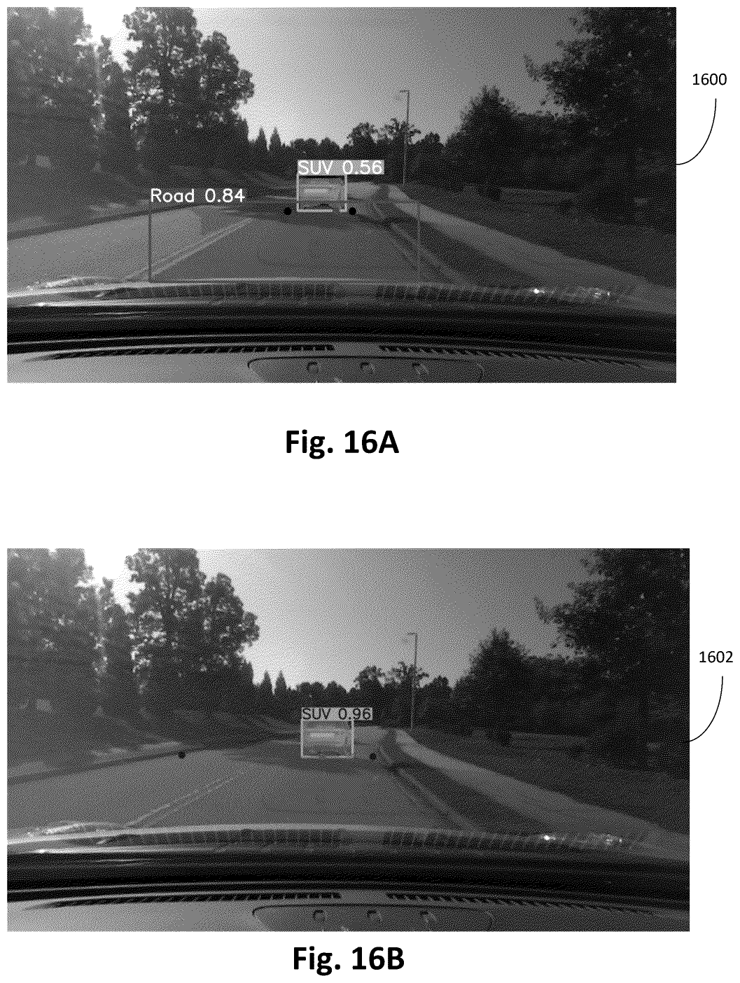

Referring to FIG. 16A, a YOLO segment 1600 demonstrates the performance characteristics of the YOLO algorithms when processing mixed reality captured images that contain challenging environmental conditions. The YOLO segmentation 1600 processes a road scene with tree shadows present on the road surface, representing typical lighting conditions encountered during outdoor mixed reality validation operations. The YOLO segmentation 1600 identifies road boundaries and segments the drivable surface area but exhibits segmentation noise and reduced accuracy when tree shadows create irregular lighting patterns across the road surface.

The YOLO segmentation 1600 shows limitations in handling complex lighting conditions where shadows create contrast variations that can be misinterpreted as road boundary changes or surface discontinuities. The segmentation noise in the YOLO segmentation 1600 results from the algorithm's sensitivity to pixel intensity variations caused by environmental factors such as tree shadows, cloud cover, and varying sun angles during different times of day.

Referring to FIG. 16B, a SAM 2 segmentation 1602 demonstrates significantly improved performance when processing the same mixed reality captured image containing tree shadows on the road surface. The SAM 2 segmentation 1602 uses the Meta Segmentation Anything Model 2 that targets video segmentation processing and provides more robust road boundary detection under challenging lighting conditions compared to the you only look once segmentation 1600.

The SAM 2 segmentation 1602 exhibits substantially lower segmentation noise when processing images with tree shadows and other environmental factors that compromise road surface visibility. The SAM 2 segmentation 1602 maintains more consistent road boundary identification across areas where shadows create lighting variations, providing more reliable segmentation results for the local object pose correction 206 algorithms that depend on accurate road boundary detection for virtual object positioning.

The comparison between the you only look once segmentation 1600 and the SAM 2 segmentation 1602 demonstrates the trade-off between computational efficiency and segmentation accuracy under challenging environmental conditions. The you only look once segmentation 1600 provides faster processing speeds that support real-time road segmentation during mixed reality operations, while the SAM 2 segmentation 1602 offers superior accuracy at the cost of increased computational requirements.

The SAM 2 segmentation 1602 can be implemented as an alternative segmentation tool when the noise from environmental factors such as tree shadows is high and the update frequency requirements allow for more computationally intensive processing. The SAM 2 segmentation 1602 provides more robust performance in correcting the pose of virtual objects when challenging lighting conditions compromise the accuracy of the you only look once segmentation 1600 results.

The segmentation method selection impacts the effectiveness of the local object pose correction 206 algorithms that rely on accurate identification of the segmented road area 604 and the road boundary 608 for pixel-based analysis and coordinate adjustments. The SAM 2 segmentation 1602 provides more reliable road boundary detection that enhances the accuracy of lateral position correction and pitch angle correction calculations used to maintain proper virtual object positioning relative to the physical road surface.

The communications system 102 incorporates Network Time Protocol (NTP) for high-level planning synchronization and Precision Time Protocol (PTP-v4) for higher accuracy requirements to synchronize on-board network devices within microseconds. The timing synchronization enables coordinated operation between the segmentation processing algorithms and the mixed reality display systems, ensuring that the you only look once segmentation 1600 or the SAM 2 segmentation 1602 results are processed and applied to virtual object positioning within the temporal requirements of the enhanced frame rate algorithms operating at 120 Hz update frequency.

Referring to FIG. 17, the communications system 102 implements a distributed network architecture that enables coordinated operation between on-board vehicle systems and remote computational resources through systematic data flow management and timing synchronization protocols. The cellular network gateway 1700 serves as the primary interface between the mixed reality validation system and external network infrastructure, providing connectivity to remote systems and enabling distributed processing capabilities that support the enhanced frame rate algorithms and real-time pose correction operations.

The network router 1702 functions as the central hub within the communications system 102 architecture, managing data flow between multiple system components and coordinating communication protocols to ensure synchronized operation across all connected devices. The network router 1702 connects directly to the cellular network gateway 1700 to establish external network connectivity while simultaneously managing internal network traffic between on-board and remote computational resources.

The remote computer device 1704 provides off-board computational capabilities that support the traffic microsimulation 202 and the global environment reference 204 processing requirements. The remote computer device 1704 connects to the network router 1702 through high-bandwidth data links that enable real-time exchange of traffic simulation data, environmental reference information, and coordinate transformation parameters needed for accurate virtual object positioning within the mixed reality environment.

A vehicle computer device 1706 manages on-board computational tasks including the local object pose correction 206, the ego vehicle coordinate initialization 200, and real-time processing of sensor data from the sensors 116. The vehicle computer device 1706 interfaces with the network router 1702 to receive processed traffic simulation data from the remote computer device 1704 while simultaneously providing real-time vehicle state information and sensor measurements to support distributed processing operations.

The sensor 1708 connects to the vehicle computer device 1706 to provide real-time measurement data including position positioning information, IMU acceleration data, and environmental sensing inputs that support the enhanced frame rate Kalman filter algorithms. The sensor 1708 data flows through the vehicle computer device 1706 to the network router 1702, enabling both local processing for immediate control responses and remote processing for complex simulation and reference generation tasks.

The antenna 1710 connects to the network router 1702 to enable wireless communication capabilities throughout the system architecture, supporting both cellular network connectivity through the cellular network gateway 1700 and local wireless communication between system components. The antenna 1710 facilitates real-time data exchange between the mixed reality headset 702, the camera 700, and the vehicle computer device 1706 during mixed reality validation operations.

The network topology implements a hybrid architecture that combines centralized coordination through the network router 1702 with distributed processing capabilities across the remote computer device 1704 and the vehicle computer device 1706. The centralized coordination ensures synchronized operation of all system components while the distributed processing enables computational load balancing between on-board real-time requirements and off-board complex simulation tasks.

The data flow paths within the communications system 102 enable bidirectional information exchange between all connected components through the network router 1702. Traffic simulation data flows from the remote computer device 1704 through the network router 1702 to the vehicle computer device 1706, where the data is processed with real-time sensor measurements from the sensor 1708 to generate accurate virtual object positioning information for the mixed reality headset 702.

Real-time vehicle state information flows from the vehicle computer device 1706 through the network router 1702 to the remote computer device 1704, enabling the traffic microsimulation 202 to maintain accurate digital twin representation of the ego vehicle within the simulation environment. The bidirectional data flow ensures that virtual traffic objects respond appropriately to real vehicle motion while maintaining synchronized interaction between physical and virtual elements.

The communications system 102 implements network time protocol (NTP) for high-level planning synchronization that coordinates timing between the remote computer device 1704 and the vehicle computer device 1706 during traffic simulation and route planning operations. The NTP synchronization ensures that traffic simulation updates from the remote computer device 1704 align temporally with real-time vehicle measurements processed by the vehicle computer device 1706, maintaining consistent timing relationships across distributed computational resources.

Precision time protocol (PTP) provides higher accuracy timing synchronization for on-board network devices connected through the network router 1702, achieving microsecond-level timing precision between the vehicle computer device 1706, the sensor 1708, and other real-time system components. The PTP synchronization supports the enhanced frame rate algorithms operating at 120 Hz update frequency by ensuring that sensor measurements, pose corrections, and virtual object updates maintain precise temporal alignment.

The microsecond-level timing precision achieved through PTP enables the local object pose correction 206 algorithms to process sensor data from the sensor 1708 and apply corrections to virtual object positioning within the temporal requirements of the mixed reality display systems. The precise timing synchronization ensures that the you only look once segmentation 1600 or the SAM segmentation 1602 processing results are applied to virtual object positioning without introducing temporal delays that can compromise the realism of virtual traffic interactions.

The communications system 102 architecture enables both on-board and off-board computation through systematic distribution of processing tasks based on real-time requirements and computational complexity. On-board computation through the vehicle computer device 1706 handles time-critical tasks including sensor data processing, pose correction calculations, and immediate control responses that require minimal latency for safe vehicle operation and realistic mixed reality visualization.

Off-board computation through the remote computer device 1704 manages computationally intensive tasks including traffic simulation generation, complex coordinate transformations, and reference trajectory processing that can tolerate higher latency while providing enhanced computational capabilities beyond the constraints of on-board systems. The distributed computation approach optimizes system performance by allocating processing tasks according to timing requirements and computational resource availability.

The network router 1702 manages quality of service protocols that prioritize real-time data flows between the vehicle computer device 1706 and the sensor 1708 while ensuring adequate bandwidth allocation for communication with the remote computer device 1704 through the cellular network gateway 1700. The quality of service management maintains consistent data flow rates that support the enhanced frame rate algorithms and prevent communication delays that can compromise mixed reality system performance during validation operations.

According to one embodiment, the processes, techniques and functionality described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the processes, techniques and functionality, or may include one or more general purpose hardware processors configured, adapted and programmed to perform the processes, techniques and functionality pursuant to program instructions, such as computer readable instructions, in firmware, memory, other storage, or a combination. Such special-purpose computing devices may also combine custom hard-wired logic, ASICs, or FPGAs with custom programming to accomplish the processes, techniques and functionality. The special-purpose computing devices may be desktop computer systems, portable computer systems, handheld devices, networking devices or any other device that incorporates hard-wired and/or program logic to implement the processes, techniques and functionality.

The terms “module,” “framework,” “SDK,” and “process” as used herein refer to implementations that may be realized through computer readable instructions stored on tangible, non-transitory computer readable media to provide tangible articles of manufacture. These terms are well understood by those skilled in the art as means for communicating the structural and functional aspects of the disclosed mixed reality system. Each of these components may be embodied as software modules, hardware implementations, or combinations thereof, executing specific functions within the overall system architecture. For example, the planner module 112 may be implemented as computer readable instructions that process environment information 108 and environment articles 110 to generate planning decisions, while the traffic microsimulation 202 framework may comprise software algorithms that generate virtual traffic scenarios with position, velocity, and acceleration data. The local object pose correction 206 process may include computer vision algorithms implemented through executable code that performs real-time analysis of captured images to detect positioning errors and calculate pixel-based corrections for virtual traffic objects.

The functionality, processes, procedures, equations, algorithms, and steps described herein can be implemented with computer readable instructions stored on a non-transitory computer readable medium and executed on a computer device to provide tangible articles with real world application. The mixed reality coordinate transformation algorithms, traffic microsimulation processing, local object pose correction calculations, Kalman filter implementations, computer vision algorithms for road segmentation and virtual object detection, pixel-based correction computations, enhanced frame rate processing, and communications system coordination can be embodied as software instructions that, when executed by a processor, cause the computer device to perform the described operations and generate practical, tangible results. The mathematical relationships for coordinate transformations, lateral position corrections, pitch angle adjustments, speed gap calculations, reaction time measurements, and pose error determinations may be implemented as executable code that processes real-time sensor data and generates corrected virtual object positioning for mixed reality vehicle validation systems. The YOLO and SAM segmentation algorithms, Network Time Protocol and Precision Time Protocol synchronization procedures, and distributed computing architecture coordination may be realized through computer program instructions that enable real-world mixed reality testing and validation of advanced driver assistance systems and autonomous vehicle technologies.

One or more different inventions may be described in the present application. Further, for one or more of the invention(s) described herein, numerous embodiments may be described in this patent application, and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A mixed reality system for vehicle testing and validation comprising:
a computer system;
a vehicle platform including a vehicle controller and a sensor array in communications with the computer system;
a mixed reality headset in communications with the computer system configured to superimpose virtual traffic objects onto a real-world driving environment through optical see-through display technology;
a traffic microsimulation module included in the computer system and configured to generate virtual traffic scenarios and provide position, velocity, and acceleration data of virtual vehicles;
a local object pose correction module included in the computer system and configured to process captured images from the real-world driving environment to detect positioning errors of the virtual traffic objects relative to road boundaries and calculate pixel-based corrections to maintain accurate spatial alignment between the virtual traffic objects and physical road surfaces; and
a communications system included in the computer system and configured to coordinate data exchange between the vehicle platform, the mixed reality headset, the traffic microsimulation module, and the local object pose correction module.

2. The mixed reality system of claim 1, wherein the vehicle controller is configured to operate the vehicle platform in a drive-by-wire mode with automated steering, throttle, and brake actuation.

3. The mixed reality system of claim 1, wherein the sensor array comprises a position positioning system, an inertial measurement unit, and at least one camera configured to capture real-world driving environment images.

4. The mixed reality system of claim 3, wherein the local object pose correction module is configured to process the captured images using computer vision algorithms to perform road segmentation and virtual object detection.

5. The mixed reality system of claim 4, wherein the computer vision algorithms comprise YOLO for real-time road segmentation and object detection.

6. The mixed reality system of claim 1, wherein the local object pose correction module implements Kalman filters to provide smooth temporal corrections for both lateral positioning and pitch angle adjustments of the virtual traffic objects.

7. The mixed reality system of claim 6, wherein the Kalman filters operate to eliminate positioning discontinuities and maintain continuous virtual object motion at the enhanced frame rates.

8. A digital system for mixed reality vehicle validation, comprising:
a computer system adapted for:
initializing coordinate transformations between a vehicle platform and a mixed reality headset to align virtual traffic objects with a real-world driving environment;
generating virtual traffic scenarios through traffic microsimulation that provides dynamic position, velocity, and acceleration data for virtual vehicles;
capturing real-time images of the driving environment during vehicle operation;
processing the captured images to detect road boundaries and identify positioning errors of virtual traffic objects relative to the road boundaries;
calculating pixel-based corrections for the positioning errors using lateral position correction and pitch angle correction algorithms;
applying Kalman filter processing to the corrections to provide smooth temporal transitions; and
updating positions of the virtual traffic objects to maintain realistic spatial relationships with physical road surfaces.

9. The digital system of claim 8, wherein the coordinate transformations comprise transforming virtual traffic object positions from global coordinates to ego vehicle coordinates and from ego vehicle coordinates to mixed reality headset coordinates.

10. The digital system of claim 8, wherein processing the captured images comprises using computer vision algorithms selected from YOLO and SAM model for road segmentation and virtual object detection.

11. The digital system of claim 10, wherein the computer vision algorithms output road segmentation regions and virtual vehicle detection boxes that provide spatial reference data for position correction calculations.

12. The digital system of claim 8, wherein calculating pixel-based corrections comprises determining a target lateral position and calculating a lateral correction offset.

13. The digital system of claim 12, wherein the Kalman filter processing incorporates the lateral correction offset to predict future lateral position changes.

14. A mixed reality validation computerized platform, comprising:
a drive-by-wire vehicle including sensors included in a computer system for real-time positioning and environmental perception;
an optical see-through mixed reality display system in communications with the computer system configured to overlay virtual vehicles onto a driver's view of a physical driving environment;
a vision system included in the computer system configured to perform real-time road segmentation and virtual object detection on captured images to identify spatial misalignments between virtual traffic objects and road surfaces;
a pose correction module included in the computer system configured to calculate lateral and vertical positioning adjustments based on pixel differences between detected virtual object positions and target road surface positions; and
wherein the computer system is adapted to provide a distributed computing architecture including on-board and remote computational resources coordinated through a network router to process traffic simulation data and apply positioning corrections.

15. The mixed reality validation platform of claim 14, wherein the sensors comprise a position positioning system providing centimeter-level accuracy through fusion of real time kinematic, global positioning, and inertial measurement data.

16. The mixed reality validation platform of claim 15, wherein the pose correction algorithm implements Kalman filters for both lateral positioning corrections and pitch angle corrections to provide smooth temporal transitions at the update frequencies.

17. The mixed reality validation platform of claim 16, wherein the Kalman filters process correction inputs according to lateral trajectory correction prediction and pitch correction prediction.

18. The mixed reality validation platform of claim 14, wherein the computer vision system uses a YOLO model for real-time road segmentation and a SAM model for enhanced segmentation accuracy under challenging lighting conditions.

19. The mixed reality validation platform of claim 14, wherein the distributed computing architecture coordinates timing synchronization for high-level planning operations and precision time protocol for microsecond-level synchronization of on-board network devices.
